(19) United States
(12) Patent Application Publication
(10) Pub. No.: US 2025/0005828 A1
(43) Pub. Date: Jan. 2, 2025

(54) METHOD, SYSTEM AND COMPUTER PROGRAM PRODUCT FOR MANAGEMENT AND REVIEW OF PRODUCT CONSUMER MEDICINE INFORMATION

(71) Applicant: SecureCHEK AI, INC., New York, NY (US)

(72) Inventors: Ilyssa LEVINS, New York, NY (US); Gil HENZEL, Palo Alto, CA (US); Assaf FLIESCHER, Tel Aviv (IL); Ran SHNEOR

(21) Appl. No.: 18/709,299

(22) PCT Filed: Nov. 10, 2022
(86) PCT No.: PCT/IL2022/051200

§ 371 Date: May 10, 2024

Related U.S. Application Data
(60) Provisional application No. 63/263,943, filed on Nov. 11, 2021.

(51) Int. Cl. G06T 11/60; G06F 16/23; G06F 40/197; G06F 40/289

(52) U.S. Cl. CPC G06T 11/60; G06F 16/2336; G06F 40/197; G06F 40/289

(57) ABSTRACT

A system facilitating authoring of content, the system comprising a plurality of catalogues (aka “data catalogues”) associated in memory with, and storing, in the memory, data regarding, a respective plurality of authorized documents, each having content known to be compliant with at least one regulation; and at least one hardware processor configured to interface with plural end-users and to review at least one new document comprising a new version associated by an individual end-user from among the plural end-users with an individual authorized document from among the plurality of authorized documents, by comparing the new document to the catalogue from among the plurality of catalogues which is associated in memory with said individual authorized document and, accordingly, generating at least one output facilitating editing of the new document for compliance with the regulation/s.

### REFERENCE TO CO-PENDING APPLICATIONS

Priority is claimed from U.S. Provisional Patent Application No. 63/263,943, entitled “Method, system and computer program product for management and review of product consumer medicine information” and filed on Nov. 11, 2021, the disclosure of which is hereby incorporated herein by reference.

### FIELD OF THIS DISCLOSURE

The present invention relates generally to automatic tools for authoring content.

### BACKGROUND FOR THIS DISCLOSURE

There are existing methods for general document layout understanding which understand the document layout using visual features and by that the order of words, such as for example
https://patents.google.com/patent/US4887212A/en
https://patents.justia.com/patent/20060095250

Many software tools exist for authoring documents.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments provide a solution to the technical problem of improving the speed and/or accuracy of document authoring e.g., by virtue of any embodiment herein, which may be configured for automatically checking regulated content for regulatory compliance, making any authoring system used in conjunction with embodiments herein a more efficient and effective system for the user to use. The system herein may be used in conjunction with authoring/design tools such as, say, MS-WORD or other word processors, Adobe InDesign, Photoshop, Illustrator, to more efficiently generate documents, using the authoring/design tools, which maintain regulatory compliance vis a vis at least one regulation applicable to documents, including documents which are later versions relative to earlier versions which are known to be compliant with the at least one regulation.

For example, certain embodiments herein generate KPIs (Key Performance Indicators) and/or reports and/or otherwise flag or highlight non-compliant content in a new document that may have been authored using the authoring system. The system user may use the error report to edit the document, e.g. using the authoring system/s, thereby to yield another new document, which is a newer version, and the system may then review the newer version, and again generate KPIs and/or reports and/or otherwise flag or highlight non-compliant content in that version, and so forth, until eventually, a version results which is entirely compliant with applicable regulation/s.

The current process of manually reviewing of safety and marketing content used for medical products requires considerable time and resources. The review process of such content typically includes various manual operations respectively covering various aspects of the processed document e.g., as described herein. It usually also requires coordination and numerus repeating iterations between different reviewers leading to the approved finalised document.

Understanding the correct reading order of words in their “natural” reading order is a relatively easy task for a human, but is non-trivial for a computer to perform; thus, this problem is still an active research topic in computer science; any suitable known techniques or natural language processing technologies may be employed, including but not limited to those specifically described herein.

Certain embodiments seek to provide a tool for management and review of product consumer medicine information.

Certain embodiments seek to provide a system for parsing and/or analysing content including determining whether certain regulatory requirements e.g., FDA requirements, are met by the content, using AI and/or machine learning and/or natural language processing.

Certain embodiments seek to provide a system for management reviewing and validation of typically legal-sensitive medical safety and marketing related content such as but not limited to consumer medicine information, which may, for example, comprise a brochure or an insert provided to persons buying the relevant medicine e.g., inside or on the medicine's packaging.

Certain embodiments seek to provide a workflow for label change including searching for at least one change to be made to at least one catalogue and/or at least one new document, when a regulation e.g., FDA regulation or corporate or end-user specific regulation has been changed.

Certain embodiments provide a regulated content-checking system including logic for reading content from an uploaded document, including determining the order in which the content should be read, thereby to provide uploaded ordered content, and/or logic which flags all portions of the uploaded ordered content which are non-compliant.

The terms “flagging”, “pinpointing”, and “highlighting” may be interchanged herewithin.

“Non-compliance”, which may be flagged, may include any element (graph/image etc.) which is added to a new document and is not in the catalogue, or any element which is absent from a new document and is present in the catalogue, or any set of elements present in the document (as well as in the catalogue), but not in the predetermined order defined in the catalogue.

Certain embodiments facilitate authoring of a document which is an update of existing compliant drug literature. To check if the updated literature remains compliant, the system need not check the new version from scratch, and instead may compare the updated version to the (known-to-be-compliant) older version. The system may rely on the fact that content identified as having been “inherited” from the old version, is compliant, hence need not be re-checked. The system typically is configured for comparing new content against an existing library of approved content. If the information or literature was changed or updated, the system may flag only that specific content as a deviation which may then be reviewed and approved by humans to confirm the update is correct. According to certain embodiments, new content, once approved, may then be used to update the library, and, subsequently, new materials coming in with the same updated information that were flagged as a deviation from the approved content, may then go through the system without being flagged.

The system's knowledge of the older document (aka approved document) may be stored as a catalogue which may include any suitable metadata about the older document (to facilitate checks of a newer version thereof) e.g., as described herein. For example, the metadata may include data indicating locations of images or graphs within the document, and/or the word order of the words/phrases in the approved document e.g., an ordered list or sequence of the words in the approved document.

Typically, there is versioning control in the system. The system may be trained or configured (e.g., via catalogue metadata) to know which content must be 100% matched, such as important safety information and certain claims, vs. other marketing information which need not be 100% matched to the catalogue. If content is updated in a new document, and the content has to match 100%, without deviation, the system will flag that update, as well as flagging, as new content, any content totally foreign to the library.

Certain embodiments of the system herein generate various KPIs and reports which flag non-compliant content. The system user may use the error report to go back into legacy authoring systems such as Adobe inDesign to make the changes. The system use may then re-upload the corrected document into the system described herein, to determine that the corrected document is compliant, until eventually, a compliant document results. It is appreciated that embodiments herein can be used in conjunction with authoring/design tools such as, say, MS-WORD or other word processors, Adobe inDesign, Photoshop, or Illustrator, to check for regulatory compliance. Conventional authoring systems do not develop components or modules (such as important safety information or an efficacy claim) from existing content and ensure they remain compliant.

Typically, the system is agnostic in terms of content; having created a library of approved content and, typically, associated metadata such as rules governing that content, anything can be fed into the system herein for checking, including, for example, text, charts, graphs. The system then typically is configured to flag deviations, new content, or missing context. Thus the system may be used for any and all type of regulated/professional/formalized/stylized literature including installation manuals, user manuals for household equipment or engineering equipment or other hardware, software design documents, and medicine literature.

Providing a subsystem for creation and managing a data catalogue, such as any catalogue shown and described herein, may include providing a list or set of rules and checks which may be defined as mandatory during the review process of a new document. Rules may include rules for checking and validation of specific text (single or multiple sentences text) and/or rules may define certain figures, tables, and/or lists as being mandatory by regulations. Rules may also include validation checks for mandatory external literature reference text.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operation and instead, the remote processor P itself may receive output/s of portion/s of the operation from yet another processor/s P′, may be deployed off-shore relative to P, or “on a cloud”, and so forth.

There is thus provided, The present invention typically includes at least the following embodiments:

Embodiment 1. A system facilitating authoring of content, the system comprising a plurality of catalogues (aka “data catalogues”) associated in memory with a respective plurality of authorized documents, and storing, in the memory, data regarding the respective plurality of authorized documents, each of which has content known to be compliant with at least one regulation; and/or at least one hardware processor configured to interface with plural end-users and to review at least one new document comprising a new version associated, typically by an individual end-user from among the plural end-users, with an individual authorized document from among the plurality of authorized documents, the review typically including comparing the new document to the catalogue from among the plurality of catalogues which is associated in memory with the individual authorized document and, accordingly, generating at least one output facilitating editing of the new document for compliance with the regulation.

Embodiment 2. A system according to any of the preceding embodiments and also comprising automated functionality for creation, management, and storing of catalogues, thereby to provide the plurality of catalogues.

Embodiment 3. A system according to any of the preceding embodiments wherein the output comprises at least one KPI.

Embodiment 4. A system according to any of the preceding embodiments wherein the output comprises at least one error report.

Embodiment 5. A system according to any of the preceding embodiments wherein each of the plural end-users is defined as a system user and at least one of the plural end-users is associated in memory with at least one catalogue C to which at least some other end-users from among the plural end-users do not have access, by creating a work environment in which the catalogue C is created and associating the plural end-users with different work environments in which different catalogues are created.

Embodiment 6. A system according to any of the preceding embodiments wherein the hardware processor identifies phrases in at least one new document, and, when reviewing at least one new document, performs at least one phrase-level analysis of the new document on the phrases.

Embodiment 7. A system according to any of the preceding embodiments wherein, before performing the phrase-level analysis, the hardware processor merges at least one sequence of at least two consecutive phrases identified in the at least one new document, into a single phrase, and performs the phrase-level analysis on the single phrase inter alia.

Embodiment 8. A system according to any of the preceding embodiments wherein, before performing the phrase-level analysis, the hardware processor splits at least one phrase identified in the at least one new document, into two consecutive phrases, and performs the phrase-level analysis on each of the two consecutive phrases inter alia.

Embodiment 9. A system according to any of the preceding embodiments wherein the hardware processor is configured for finding modular content in the at least one new document.

Embodiment 9. A system according to any of the preceding embodiments wherein the hardware processor is configured for detecting at least one of tables/graphs/blocks in the new document.

Embodiment 10. A system according to any of the preceding embodiments wherein the generating at least one output comprises highlighting at least one deviation between content of the at least one new document and the catalogue.

Embodiment 11. A system according to any of the preceding embodiments wherein the system is in data communication with at least one document authoring system used by the plural end-users to author the at least one new document.

Embodiment 12. A system according to any of the preceding embodiments wherein the document authorized system is also used by the plural end-users to author the plurality of authorized documents.

Embodiment 13. A system according to any of the preceding embodiments wherein the document authoring system comprises a word processor.

Embodiment 14. A system according to any of the preceding embodiments wherein the document authoring system comprises image editing software such as but not limited to Photoshop.

Embodiment 15. A system according to any of the preceding embodiments wherein the comparing the new document to the catalogue comprises determining word order in the new document, and then comparing order of content in the new document to order of the same content in the catalogue.

Embodiment 16. A method facilitating authoring of content, the method comprising:

Providing a plurality of catalogues (aka “data catalogues”) associated in memory with, and storing, in the memory, data regarding, a respective plurality of authorized documents, each having content known to be compliant with at least one regulation; and

Using at least one hardware processor configured to interface with plural end-users to review at least one new document comprising a new version associated by an individual end-user from among the plural end-users with an individual authorized document from among the plurality of authorized documents, by comparing the new document to the catalogue from among the plurality of catalogues which is associated in memory with the individual authorized document and, accordingly, generating at least one output facilitating editing of the new document for compliance with the regulation.

Embodiment 17. A computer program product, comprising a non-transitory tangible computer readable medium having computer readable program code embodied therein, the computer readable program code adapted to be executed to implement a method facilitating authoring of content, the method comprising: Providing a plurality of catalogues (aka “data catalogues”) associated in memory with, and storing, in the memory, data regarding, a respective plurality of authorized documents, each having content known to be compliant with at least one regulation; and using at least one hardware processor configured to interface with plural end-users to review at least one new document comprising a new version associated by an individual end-user from among the plural end-users with an individual authorized document from among the plurality of authorized documents, by comparing the new document to the catalogue from among the plurality of catalogues which is associated in memory with the individual authorized document and, accordingly, generating at least one output facilitating editing of the new document for compliance with the regulation.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), or a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing systems, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein. which may. for example. include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

According to certain embodiments, new document content is approved phrase by phrase, or sentence by sentence, typically after merging at least one pair of sentences or phrases into a single phrase, and/or after splitting at least one sentence or phrase into plural sentences or phrases. Typically, once approved content or new document content which matches the catalogue has been identified, at least one deviation in the new document content, which has not been identified as approved content, is highlighted. Typically, all portions of the new document content, which have not been identified as approved content, are highlighted.

According to certain embodiments, a cyclic workflow is provided in which approved new material is used later, when approving even newer material, thereby to efficiently and systematically pinpoint deviations of new materials, vis a vis older approved materials. For example, if a new document, aka version 2, is approved by comparison to an approved document, aka version 1, then once version 2 is approved, version 2 may be stored in catalogue form, and version 1 may be discarded from the catalogue, and the next new document, aka version 3, may, as a result, be approved by comparison to version 2, not version 1.

It is appreciated that completing precheck of a new document may involve several versions, using stet/cycle phrase status, and document complete/finalize statuses.

Upon completion, the document is deemed to have been approved e.g. by MLR and can be loaded to the library. Typically, when the document is approved, approved phrases/blocks/tables/graphs (or the entire document) is/are added to the library.

At least the following embodiments are also provided:

Embodiment a1. An automatic proofreading inspection system, method or computer program product that reviews medical marketing documents, thereby to reduce compliance risk and/or improve quality scan processes and/or facilitate sharing of marketing documents among plural end-users.

Embodiment a2. A system, method, or computer program product comprising functionality for automated medical content review.

Embodiment a3. A system, method, or computer program product comprising functionality for generating and/or checking audit trails.

Embodiment a4. A system, method or computer program product wherein at least 2 classes of end-users are defined including at least one of medical marketing document reviewers and/or medical marketing document creators.

Embodiment a5. A system, method, or computer program product comprising functionality configured to detect new content.

Embodiment a6. A system, method, or computer program product comprising functionality configured to detect errors.

Embodiment a7. A system, method or computer program product comprising functionality configured to check compliance with known requirements.

Embodiment a8. A system, method or computer program product comprising functionality configured to provide consumer content management, including, typically, at least one of the following functionalities e.g. as shown in FIG. 6 (phrase main rule):
Manage the life cycle of the document review process.
Load new marketing content for review (pdfs, textual numerical and graphical content).
Allow users to build and manage catalogues of pre-approved content.
Create manage and apply, content review rules check list for different products.
Perform comprehensive cross-check of the consumer medicine information during the validation of new marketing content.
Deliver KPIs, and progress report during the review process.
Assign different documents and tasks to different users for review.
Enable tracking of the entire review life-cycle progress.

The term “approved” as used herein may include content known to be compliant with regulation e.g., by virtue of having been included into a catalogue as such. the term “approved” as used herein may include any new document content which is also included in a catalogue relevant to the document being reviewed, whereas non-approved content comprises all deviations in the new document from content included in the catalogue relevant to the new document being reviewed.

Embodiment a9. A system, method or computer program product comprising functionality configured to provide document reviewing and inspections (GUI) typically including at least one of the following functionalities:
A dedicated pdf viewer tool for the inspecting of pdf documents during the review process.
Panning and zooming on the entire reviewed document and allowing to focus on specific pages/phrases/words.
Highlighting reviewed phrases during the review process, to compare against the catalogue.
Visually mark and indicate for valid vs non-approved content.
Deliver specific warnings for non-approved and new content.
Allow GUI for editing and viewing results of specific rule-based content checks.
Highlight content references, matching the reference phrase to the referenced phrase.

Embodiment a10. A system, method or computer program product comprising functionality configured to provide inspection of the review process progress, typically including at least one of the following functionalities:
Compare reviewed content to catalogue.
Alert for any new content/phrase which was not pre-approved and can be used in the product content.
Alert for any required content/phrase which was not found in the reviewed content.
Show the most similar phrases already existing in the product catalogue.
Suggest, per phrases, what are the extra/missing words, compared with the most similar catalogue entries.
Show any variations between the inspected material and the existing catalogues.
Tool for generating reports for the review progress.
Report the number of phrases with existing catalogue matches vs non-matching phrases.

Embodiment a11. A system, method or computer program product comprising functionality configured to provide a system user's environment and permissions management, typically including at least one of the following functionalities:
Create separate user environments and for different users which are associated to companies/documents/catalogues when managing the review process.
Manage users with different permissions, roles, and tasks associated with each user or group of users.
Content catalogues management tool-manage and maintain user, product and company specific pre-approved content DB tables.

### BRIEF DESCRIPTION OF THE DRAWINGS

Example embodiments are illustrated in the various drawings. Specifically:

FIGS. 1-25 are example screen displays, all or any subset of which may be displayed to an end-user of any system described herein, including inter alia:

FIG. 1 presents an example main menu;

FIG. 2 presents an example manage environments screen display;

FIG. 3 presents an example manage products screen display which may be used by end-users to link products to environments;

FIG. 4 presents an example pre-check document selection menu;

FIG. 5 presents an example main document pre-check view screen;

FIG. 6 presents an example single phrase check & comparison window;

FIG. 7 presents an example main phrase viewer screen phrases, including linked references;

FIG. 8 presents an example main phrase screen including top menu statistics;

FIG. 9 presents an example screen display useful for catalogue selection documents;

FIG. 10 presents an example screen display useful for catalogue images selection;

FIG. 11 presents an example phrase type menu;

FIG. 12 presents example asset types;

FIG. 13 presents an example catalogue entries editing menu;

FIG. 14 presents an example catalogue images menu; the table in the second line may for example correspond to the table of FIG. 24;

FIG. 15 presents an example user information menu;

FIG. 16 presents an example modular content definition;

FIG. 17 presents an example of a block list per asset template;

FIG. 18 presents an example of block translation;

FIGS. 19 and 20 present examples of external libraries;

FIG. 21 illustrates an embodiment of the present invention;

FIG. 22 presents an example selection menu for modular content templates;

FIG. 23 is an example of a display window for a specific modular content template;

FIG. 23 illustrates one page of an example new document which may be displayed to an end-user by any embodiment of the system shown and described herein;

FIG. 24 illustrates an embodiment of the present invention; and

FIGS. 25-31 describe label change in accordance with certain embodiments.

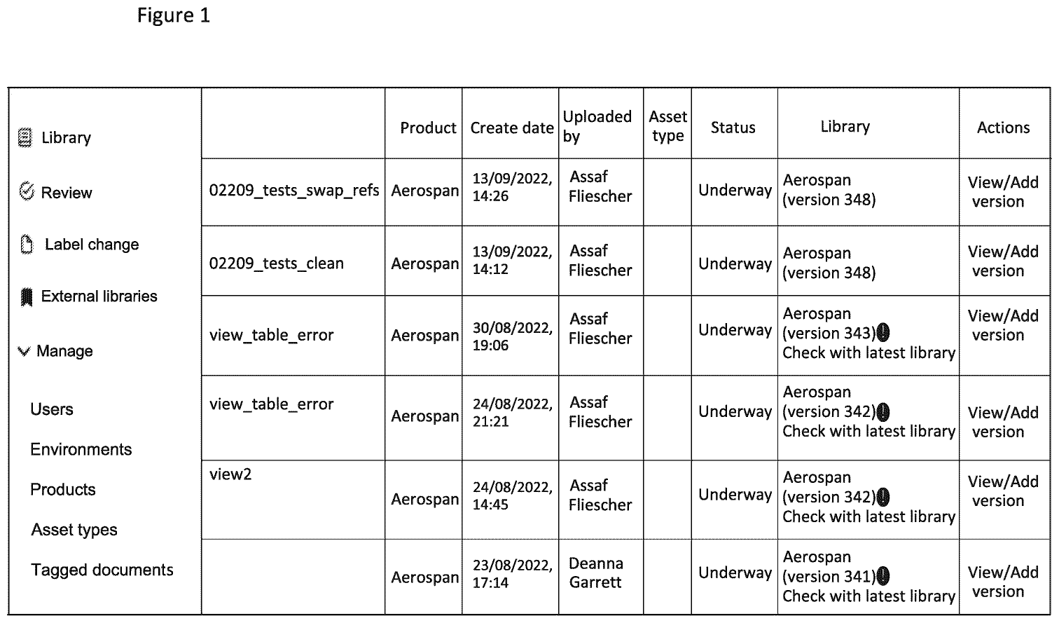

It is appreciated that in each of the FIGS. 1-31, all illustrated content, or any suitable portion thereof, may be included in screen displays generated by the system.

All or any subset of the pictorial content and of the alphanumerical content of each screenshot may be provided in practice.

Only some embodiments of the present invention are illustrated in the drawings; in the block diagrams, arrows between modules may be implemented as APIs and any suitable technology may be used for interconnecting functional components or modules illustrated herein in a suitable sequence or order e.g. via a suitable API/interface. For example, state of the art tools may be employed, such as but not limited to Apache Thrift and Avro, which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g., as shown. Tables herein may include all or any subset of the fields and/or records and/or cells and/or rows and/or columns described.

In the swim-lane diagrams, it is appreciated that any order of the operations shown may be employed rather than the order shown, however, preferably, the order is such as to allow utilization of results of certain operations by other operations, by performing the former before the latter, as shown in the diagram.

Computational, functional or logical components described and illustrated herein can be implemented in various forms, for example, as hardware circuits, such as but not limited to custom VLSI circuits, or gate arrays, or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act, or behave, or act as described herein with reference to the functional component in question. For example, the component may be distributed over several code sequences such as but not limited to objects, procedures, functions, routines, and programs, and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include any apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

Efficient management and reviewing of various safety and marketing content used for medical products requires considerable time and resources. The process also requires detailed knowledge of pre-approved content vs new content, as well as the review history of a large number of products and existing catalogues.

Determinants of the efficiency of this review process may include all or any subset of the following:
Visual assessment tools for inspecting different document items, phrases, assuring complying with regulation, and effective management of material related to this review process.
The ability to share and coordinate it between different users, companies and products.
Maintain and manage pre-approved catalogues, used as reference during the process of new content cross-check.
Track the review process progress by computing various KPIs to the content inspection life-cycle.
Suggest content additions/modification/deletions where required.
Quantitative assessment of the reviewing progress, tracking of different document items, phrases, and/or regulation enforcement, and/or effective decision-making during the review process.
Generating content which is subject to different regulations such as FDA regulations, which require methods, systems, and computer program products for effective management of this reviewing process.

While the application description presented here is focused on an application for use for reviewing medical product consumer information content, it can also be used as a solution for validating other types of regulated content documents, (for example, insurance & banking related content review).

The review process of these types of documents typically includes-
legal rule based validation—and/or
visual inspection of graphical elements/documents and/or
modifying professional non-valid user intended content.

The product methods, systems, and computer program for content management of medical marketing related materials, disclosed therein, may also apply to any other type of such of a content reviewing system, such as legal documents, banking financial documents, or insurance related document review.

Medical products content extends from general marketing content, such as consumer brochures, to user indications, and various FDA regulated content, such as product important safety information.

A new content check may include all or any of the following functionalities, in any suitable order e.g., as shown:-
1. Import safety/marketing document for review
2. Visually examining and inspecting of the document
3. Mark any pre-approved catalogue allowed content
4. Detect any new, not previously approved content which is not part of the existing catalogue
5. Modify or remove any non-valid content
6. Generate and insert any required missing content
7. Generate review process progress report
8. Repeat cycle until no further content modifications are required

In some cases, in order to have effective management of the new content checks, there may be a need to acquire additional information from all its nodes, and recirculate the document for further review, depending on the type of document and progress of the review process.

System Algorithmic Components may include all or any subset of the following:
Classify phrases to one of the following statuses:
This functionality allows the user to track the current review status. For each phrase, it shows the current phrase status and allows the user to track the total number of phrases in plural categories e.g., into all or any subset of the following categories:
Passed: Number of phrases in the document which are marked by the user as full match. (no further corrections are required).
New content: Number of phrases with no match which are identified as new content.
Evaluate variable: Number of variable phrases with only partial match which are classified as variable type phrases.
Evaluate: Number of variable phrases with only partial match which were classified as non-variable type phrases.
Stet: Number of phrases with no full match but which were manually approved by the user.
Comment: Number of phrases which were manually approved, with additional user comment included.
Apply change: Number of phrases which were manually marked by the user as phrases which require changes.
According to certain embodiments, all or any subset of the following features are provided:
   Show KPIs progress, show the change in the number of phrases under each category, (for example, 3 phrases were added to the stet category)
   Show KPIs in percentage
Create and maintain product content catalogue—including all or any subset of the following:
   Allow user to manually review and scan the document
   Import approved phrases to the product phrases catalogue
   Import approved images to the product images catalogue
   Incorporate these imported phrases and images into the product validation process
According to certain embodiments, all or any subset of the following features are provided:
   Catalogue creation and maintenance tools
      Allow for auto web search and import for textual data and image data
      Allow for auto web search for image data

### Match Phrases to a Pre-Defined Phrase Catalogue

For each document phrase, a search is performed for the most similar, (or identical) catalogue phrases listed in the product specific catalogue. In order to be able to compare the document text to text appearing in the catalogue, a phrases similarity score computation is implemented.

According to certain embodiments, the system may allow for user defined phrase similarity (e.g., allow the user to define two different phrases as equivalent phrases, allowing substitutions while performing the document validation).

### Phrase Similarity Score

This similarity score may be used to compute the similarity between two phrases (e.g., a phrase in a document being reviewed vs. a catalogue phrase). This similarity score may be computed by counting the number of identical vs non-identical words for each pair of document and catalogue sentence combination. Similarity computation also may incorporate the following features-
The general probability of each phrase dictionary word to be a part of a sentence (e.g., the relative frequency of general use of each word in the English dictionary); and/or
Computation, which, instead of using single words, also uses multiple word combination probabilities.

### Doc Phrase vs. Catalogue Phrase Comparison

This module typically compares each document phrase with the matching (most similar) catalogue phrases. The modules may enable the user to perform a visual inspection of the phrase appearing in the document compared to the most similar catalogue entry e.g. in cases where no exact catalogue match was found. This process typically includes all or any subset of the following operations, suitably ordered e.g., as follows:-
Find any extra words e.g. words that appear in the document phrase, but do not appear in the matching (most similar) catalogue phrase.
Find any missing words that appear in the matching catalogue phrase, but do not appear in the document phrase.
Generate a single “comparison” output phrase, this ‘phrase’ including words from both the scanned phrase and the catalogue match and identifying any extra and missing words.
Evaluate the most probable location in the phrase where these differences appear.
In order to provide the user with a tool for convenient visual inspection of these differences, a process may be configured to find the simplest text differences (where simplicity may, for example, be defined as being the transition between the actual document text and the catalogue entry which requires the smallest number of word re-arrangements).
   Identifying the location in the text where these differences appear may be performed by scanning and comparing the catalogue text and the reviewed document text, and for each missing/extra text section, finding a location in the text where there are the maximal identical words between the catalogue text and the reviewed document text, both before, and after the missing/extra text. This location may then be returned e.g., to a relative location of missing or extra words in the checked document text. The output of this process typically comprises an ordered sequence of words, each tagged as found/missing/extra word.
The output may then be displayed as a merged phrase showing common words appearing both in the catalogue and the text, and the missing/extra words in the most likely location in the merged text.

According to certain embodiments, the system may apply focus on unique differences between the catalogue and the document phrases text, such as number/units differences.

### Classify Document Phrases Into Specific Phrase Types

This process determines the phrase type for each phrase in the document, for example—a phrase which is part of a document safety information paragraph, phrases that are part of a reference list, etc.). This classifier may utilize plural different classification methods e.g., one or both of the following:
Applying a dictionary of keywords, to find the most probable class per each document phrase.
Uses known classes of similar phrases—after matching phrase to similar catalogue phrase, use the known catalogue phrase class, to determine the original phrase class.

According to certain embodiments, the system may provide:
Dedicated identification, extraction and processing of other types of listed information, such as side effects, directions of use, contra-indications etc.

### Split Document Characters Into Separate Words

This process assigns each character with a word id, associated with it. For example, the characters e, x, a, m, p, l, e may all be associated in memory with an ID of the word “example” which appears somewhere in, say, a new document to be reviewed.

The raw character information e.g., as read from the document, may be used to split character level information into separate words. By using the document layout and separating characters, such as space character, new line, and comma characters, the correct word assignment for each character in the document may be determined.

This process typically requires taking into account special scenarios in which the period character does not indicate a sentence break. These exceptions can include any suitable cases such as all or any subset of the following cases:
Numerical data containing period characters.
Special character cases such as bulletins, dashes, minus signs, and references characters.
Links and URL text (www.###.com)
Unique expressions (such as “et. El.”, “Mr.”, “Ph.D.”)

### Arrange Words in Correct Reading Order

Any suitable technology may be used to understand the correct reading order of words in their “natural” reading order such as but not limited to a solution which e.g., as described below. uses the location and/or font type and/or font size of each word to arrange the words in a correct natural reading order.

Typically, for each word, the system searches for the most probable candidates for the next and the previous words in the same row, in order to determine the correct reading order.

The system typically determines the probability that the next word (in natural reading order) satisfies various criteria e.g., all or any subset of the following criteria:
Next word is the word to the right of the current word (same row, but can belong to a new sentence)
Next word is the first word in a row below the current row of words (next row)
Next word is a new paragraph below the current row (new sentence)
Next word is a word that is part of a new column (e.g., located at the top left, of a new column, if such a column to the right of the current one was detected).

In order to perform this task, the system may take into account features and unique scenarios such as but not limited to all or any subset of the following:
Different page layouts—such as multiple columns
vertical/horizontal separation between paragraphs
Text alignment (Left-Centre-Right)
The physical order of the words in the document, which can sometimes include non-aligned text (vertically)
Change of font size, type. (bold, superscript)
Titles
Tables/graphs
Reference lists

According to certain embodiments, the system may:
Apply ML training tools and example data, to refine the performance of the words split and arrange process

### Split Text Into Phrases

This module uses the ordered word list from last stage and the catalogue entries. It searches for phrases which contain a catalogue match. If the partial phrase text matches a catalogue entry, the following process may be performed, including all or any subset of the following operations, suitably ordered e.g. as follows:
The phrase text is split or partitioned into the catalogue match part of the phrase text, and the rest of the phrase text.
The existing phrase is then split into two separate sentences (phrases). Each word is then assigned a phrase ID, which is then applied to split the document into these two new unique phrases.

This process is performed by applying different conditions indicating a sentence break inside the initial extracted phrase.

These conditions include-
Sentence break characters—period, question mark etc.
Text vertical/horizontal position change above a certain threshold
   Changes in font size and type

According to certain embodiments, the system may:
Allow support for other types of unique text structure
(page numbers, top/bottom page data (reference number etc.)

### Arrange Phrases in a Natural Language Reading Order

This module determines the order in which the extracted text phrases should appear in the analysed document page. The module receives a list of the separated phrases from the previously described phrases split operation. This information is then used to arrange the phrases in the most statistically probable reading order. For the system to correctly sort the phrases, suitable features are taken into account, such as for example:
Horizontal and vertical separation/breaks between phrases to determine paragraph level split and/or
Different modes of text alignment (for example-normal left alignments, titles central alignment); and/or
Multi-columns page layouts.

According to certain embodiments, the system may:
Apply ML tools and example documents, to automatize and refine the performance of the document structure analysis

### Analyse Reference Phrases

Locate reference, or are locations in the document which are pointing to a reference. The process of extracting and matching the references list sections, may include all or any subset of the following operations, suitably ordered e.g., as follows:
Locate references list sections in document (starters). This is done by searching the text. e.g.:
   By using keywords (references. ref-, etc.), and/or
   Detecting an ordered list (rows starting with 1., 2., 3./a.b.c.d . . . and/or
   Detecting special characters commonly used as reference chars and/or
   Detecting font type (superscript, subscript)
Split references list section to separate references items
Detect the starter char of each reference phrase
Locate any reference pointers appearing in the document phrases
Match each references pointer to the correct reference starter
This task can be more challenging in some scenarios, for example a document can have a number of different references appearing with the same ref character used, but in different pages in the document, each appearing below different paragraphs, with a different context.

According to certain embodiments, all or any subset of the following functionalities may be provided:
Extract references unique ID (for example 2003; 349:446-456)
Auto import of the referenced document from the web
Link reference to the web document
Display user with the referenced document
Use the referenced document as a catalogue content import source

Any suitable implementation for rules and modular content as described herein, may be employed e.g., either of the following two examples, or any combination thereof:

### EXAMPLE 1

### Rule Based Document Content Check

Scan list of user pre-defined mandatory content rules (phrases). For each of these mandatory phrases, all or any subset of the following operations, in any suitable order e.g., as follows
Check whether the phrase appears in the document.
Check the order in which these mandatory phrases appear in the document.
The outputs from this process (such as the number of predefined rules that were checked positive) are then displayed to the user, and used to compute the review process progress KPIs.

### Revision Rules Check

Apply user pre-defined revision rules, to test the document, which typically includes:
Each rule represents a specific catalogue phrase which is required to be included in the document, and/or
For each of these catalogue phrases, check that this mandatory content can be found in the document (search specific defined catalogue phrases appear in the document); and/or
Check that these phrases appear in the correct pre-defined order for these mandatory catalogue content phrases.

### EXAMPLE 2

### Modular Content Validation Check

This module may, for example, use external python/C libraries such as all or any subset of “detectron2” “Layout Parser” and Oriented FAST and rotated BRIEF (ORB) image comparison. These external python/C libraries may be used for image/document image recognition comparison and document layout parsing.

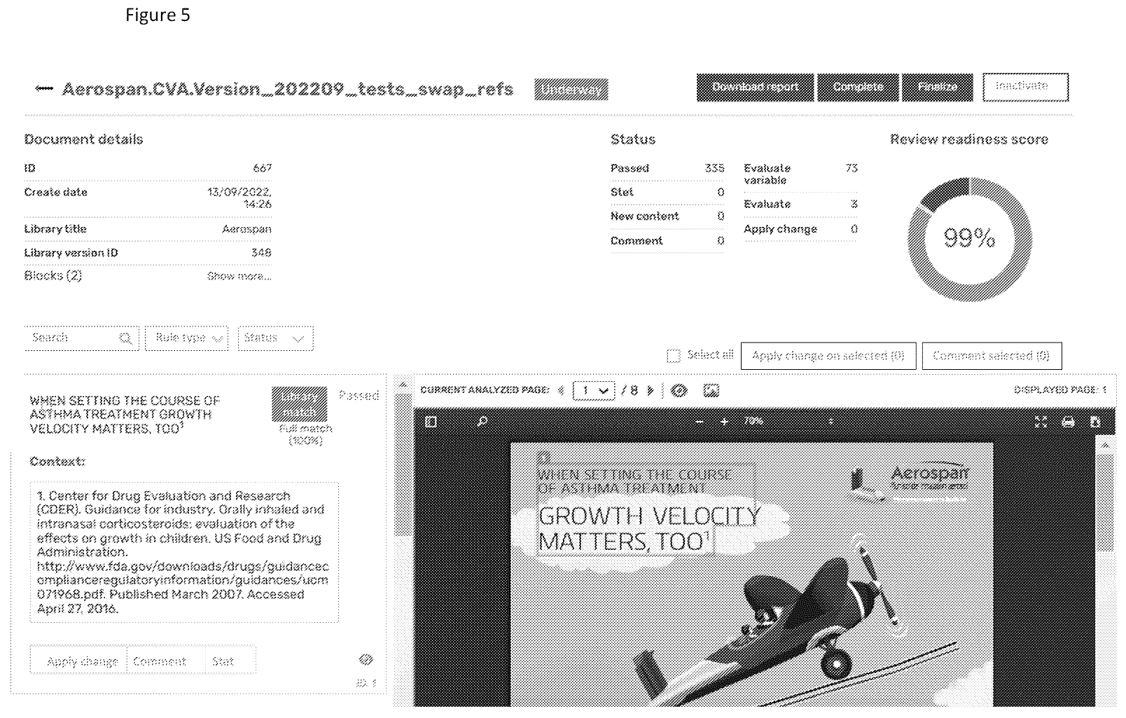

The modular content check may, for example, comprise all or any subset of the following operations, suitably ordered e.g. as follows:
Creating a new modular content catalogue
Use a modular content catalogue to review and validate a new document. An example 8-page new document bearing an image of an airplane and pertaining to asthma treatment, is presented in the screen display of FIG. 5. Documents may include sections whose content is subject to regulation, such as “important safety information”, “efficacy claims” aka “claims” and “indications” sections; these sections may or may not be so labelled in the document itself. Documents may be physically presented as brochures, websites, web-pages, paper inserts sold with a drug, labels affixed to packaging, and so forth
Important Safety Information (ISI) section identification and evaluation
Catalogue tables and images identification and evaluation
Generate final modular catalogue validation summary and compute validation KPIs

Creating a new modular content catalogue may, for example, comprise all or any subset of the following operations, suitably ordered e.g. as follows:
Analyse a document, and extract ROIs (as a list bounding boxes) in the document that contain specific content types.
Each of the extracted ROIs in a document is classified in to one of the following types-
   Textual data, which is further classified in to one of the following content sub-types-
      Separate ISI catalogue sentences (ISI sprinkled)
      A sequence of catalogue phrases (ISI)
   Images & graphs content
   Tables content
   Item lists content
The user can combine any of these different elements identified in the document, in order to create, modify, and store a unique modular content catalogue.

Use of a modular content catalogue to review and validate a new document may, for example, comprise all or any subset of the following operations, suitably ordered e.g. as follows:
Extract and classify the different modular content elements in a new checked document, using a similar process as the one used for creating a new modular content catalogue (see above).
Analyse and validate the checked document content using an existing modular content catalogue-
   Create a list of existing catalogue elements in the document
   Create a list of missing catalogue elements in the document
   Inform the user of similar documents content to the modular content elements in the catalogue, but with some variations/changes
(This is implemented using the phrase similarity score mentioned before (e.g., number of identical/missing/extra words, and word ordering)

Methods for Important Safety Information (ISI) section identification and evaluation are now described in detail. Identifying and comparing ISI/Sprinkled ISI may, for example, comprise all or any subset of the following operations, suitably ordered e.g., as follows:
Each of the catalogue phrases and document phrases is initially parsed and cleaned to enable a robust comparison (allowing tolerance for different location in the document, fonts, size, etc.)
Each document phrase is compared against each of the catalogue phrases. A full list of all the catalogue matches is then compiled.
For “Sprinkled” ISI content, a complete mapping of all the appearances of the catalogue ISI phrases in the document is generated.
For a multi-phrase ISI content, the system attempts to find the most complete (longest) sequence of ISI catalogue phrase set in the document:
   Find all the ISI catalogue phrases occurrence in the text
   For each separate phrase occurrence, check the following phrases in the document, and match to the following phrases in the catalogue. This process allows for pre-defined flexibility in the text vs catalogue comparison. This tolerance includes missing/extra phrases at the beginning, end, and inside the document ISI section.
   After identifying ISI list candidates, the most complete document ISI list identified is returned. This list is the list with the longest number of matched phrases, with the fewest number of missing phrases)

This system typically uses pre-defined parameters, such as all or any subset of the following:
The allowed maximum number of missing phrases at the beginning of the ISI section
The allowed maximum number of missing phrases at the end of the ISI section
The maximum and longest number of missing phrases in the middle of the ISI section
The maximum allowed number of “extra” phrases in the document ISI sections (e.g., phrases appearing in the document, but are not included in the modular catalogue
Tolerance for identifying a single ISI section which is split over a number of pages.

### Catalogue Image Identification and Evaluation

This typically uses various image features and image processing techniques e.g. as described below, in order to compare two images, allowing for pre-defined tolerance for various possible differences such as-
Image height/width
Image colour map
Image resolution
Overlapping/hidden image sections

The catalogue vs document image comparison may use all or any subset of the following processes:
Image RGB 1D and 2D histogram comparison
ORB-Features similarity
Mean Squared Error (MSE)
Peak Signal-to-Noise Ratio (PSNR)
Structural Similarity Index (SSIM)
Universal Quality Image Index (UQI)
Multi-Scale Structural Similarity Index (MS-SSIM)
Spatial Correlation Coefficient (SCC)
Relative Average Spectral Error (RASE
Spectral Angle Mapper (SAM)
Spectral Distortion Index (Lambda)
Spatial Distortion Index (D_S)
Quality with No Reference (QNR)
Visual Information Fidelity (VIF)
Block Sensitive—Peak Signal-to-Noise Ratio

Generate a modular catalogue validation summary and compute validation KPIs—which may include all or any subset of:
Total number of modular content elements which are found missing or modified in the checked document. This may, for example, include all or any subset of:
   Complete ISI phrases sections found/missing or modified in the document
   “Sprinkled” ISI phrases found/missing or modified in the document
   List of found/missing/modified images and graphs in the document
   List of found/missing/modified tables in the document
   List of found/missing/modified item lists in the document
Suggest modification for document content to match existing similar modular content catalogue elements.
Display to the user a summary of outputs from the comparison check process, such as:
   The number of predefined catalogue content elements that were matched
   The number of predefined catalogue content elements that were not matched
These indicators are displayed to the user, and may be used to compute the overall review process progress KPIs.

Extract different types of contact information from document:

Scan document and extract various types of contact information e.g., all or any subset of-
Email address
URL address
Telephone numbers
physical address

According to certain embodiments, all or any subset of the following features are provided:
Maintain contact details catalogue
Compare document contact information with catalogue
Extract and phrase and validate actual numerical data from tables
Use the table extracted data in order to improve and refine the document vs catalogue tables comparison.

Extract tables and graphs data:

Scan document and extract the following types of information-
Tables—e.g.:
   Format the table data in to x,y and titles data, and/or
   Compare document tables data to dictionary tables data and/or
Graphs e.g.
   Format the graph data in to x,y and axis data, and/or
   Compare document graphs to dictionary graphs data

### Spell Check

A preloaded complete dictionary is used to perform a complete spelling check of the text appearing in the document. This is done by scanning each phrase and each word, and checking that the word exists in the dictionary, and that the word spelling is correct. Typically:
Alert the user if the word does not appear in the existing dictionary, and/or
give spelling auto-suggestion for word typos

According to certain embodiments, all or any subset of the following features are provided:
Perform entire phrase/sentence level language syntax/spelling checks
Give phrase level spelling auto-suggestions
Use a customized dictionary, which includes specific medical technical terms

### Compute Document Check KPI's

Use the output of the document check to compute number of key performance indicators. These KPIs also may include all or any subset of the following:
The number of phrases which have exact catalogue phrases matches
The number of new content phrases (no catalogue match was found)
The number of phrases which require further evaluation
The number of phrases which were approved/rejected by the user during the document review.

According to certain embodiments, all or any subset of the following features are provided:
Check the progress (change) of the different KPIs
Extra KPIs e.g. all or any subset of-
   KPI based on the time/number of iterations used to evaluate document
   Number of users involved in the review process.
   Per-user statistics-number of documents validated per user etc.

### Generate Checked Document Summary Report pdf

This component uses the original document together with the results of the document review process, to create a report version of the original pdf document, showing each phrase, with the phrase status (pass/fail), the phrase type class, and the most similar catalogue phrases. It also lists the best matches per each phrase and the computed key performance indicators.

### Document Drawings

Many pdf documents also include drawing elements. In many documents a number of these elements can be grouped together into a single graphical element (such a single word, sentence, or a logo).

The processing of these elements typically includes all or any subset of the following operations, suitably ordered e.g., as follows:
Extract all document drawing elements in the document
Group these drawing elements into spatial separate graphical images. For example, join number of physically connected drawing elements (each can be a separate letter) in to a single ‘image’ which includes the entire word/phrase.
Extract all document drawings elements and save each one as an image, which can then be used for graphical element processing and matching, similar to the other “regular” jpg/gif images in the document.

### Validation Process of Document Plots Graphs and Images

This module allows the user to validate any of the graphical elements of the document, and compare each element to a catalogue of approved images. The results of this comparison are then displayed and used to generate a list of all the document approved images and new not yet approved images, which do not appear in the catalogue. The process typically includes all or any subset of the following operations, suitably ordered e.g., as follows:
Extract all plots and images from the scanned document
Compare each plot/image against all approved images appearing in the product catalogue.
Identify new images, vs images which are not yet part of the catalogue.
Allow the user to mark images as approved or non-approved images, which require further reviewing.
Enable the user to maintain a catalogue of approved images, and allow the user to import new images content.

### Optical Character Recognition (OCR)

Many documents include text, which appears only inside a graphical element, and not as actual textual data. In order to enable this content to be processed together with regular text appearing in the document, the following process may be performed, including applying all or any subset of the following operations, suitably ordered e.g., as follows:
OCR may be used in order to the extract textual data contained inside each of the document's graphical elements (images and drawings) e.g., using a dedicated OCR python library called ‘tesseract”
The extracted textual data is then parsed together with the rest of the ‘raw’ textual content of the document (e.g., apply words/phrase split, classify phrases, rule check etc.)
In addition to the OCR text output, the system also applies a module that identifies the font type and size. This enables additional processing, such as application in the phrase split process, identifying references etc.

### Removing Invisible Text

Some documents file may contain text which is embedded in the file as text but is not actually visible. This can be caused by a number of different reasons, such as the text appearing in a ‘hidden’ layer, which is obscured by other text or images. Another possible cause is some text having the same color as the background. In order to prevent using this text during the scanning and review of these documents, a dedicated module may be used. This module may be configured for applying OCR on each page, and removing text appearing in the pdf file, which does not appear in the OCR output.

Since most OCR algorithms are sensitive to the size and color of the font, this process is typically performed by applying plural different zoom factors, and various different RGB to grey filters. The different RGB to grey image transformation may include (but not limited to)-
image OCR using different zoom factors and/or
image OCR using different RGB to grey threshold values and/or
image OCR using different the ‘negative’ grey image

### Merge Phrases

This module is used in order to merge document phrases appearing in the document extracted ‘raw’ text e.g., in text extracted from a document to be reviewed, into a more human intuitive and readable text. For each two following or consecutive sentences, the system considers the probability of these sentences should be merged into a single phrase.

This may be performed by applying suitable techniques such as:
Using a pre-defined catalogue: For each two following or consecutive phrases, check whether the combined phrase matches an existing catalogue phrase, and, if so, merge the two phrases into this single phrase; and/or
Using capital letters and sentence break indicators: For each two following or consecutive phrases, check if there is no sentence break in between (criteria are physically adjacent phrases, no period, and no capital letter at the beginning of the second phrase, no font difference between the two phrases). If these conditions are met, this phrase's text is merged into a single phrase.

During the review process, this process enables performing the catalog match, without missing text which is segmented.

### EXAMPLE

### Line Segment 1

“Based on the mechanism of action, this medication can cause fatal harm when administered”

### Line Segment 2

“to a pregnant woman.”
Lines merged:
“Based on the mechanism of action, this medication can cause fetal harm when administered to a pregnant woman.”
During the merge process these two sections are merged into a single phrase, which allows the catalog match process to run without the system flagging these two phrases as phrases not appearing in the catalog.

Typically, this module uses the product phrase catalogue to check whether at least one document phrase contains a single or two existing catalogue phrases, and, if so, split the original phrase into these two separate phrases (where the result may comprise two document phrases, typically with at least one of the phrases having an exact catalogue match, or being an exact match to a phrase in the catalogue associated in memory with the new document in which the phrase/s is/are found).

This operation is performed before each phrase is tagged as a valid phrase (as a phrase which is included in the catalog). Applying this algorithm prevents tagging parts for the document which appear segmented in the document, as new content which is not part of the existing catalog.

### Adobe In-Design Templates Interface

In the present specification, “Blocks” contain a list or set of subjects such as text images tables etc that are connected visually, and “Modular content” is one block type, typically the main e.g., most common block type.

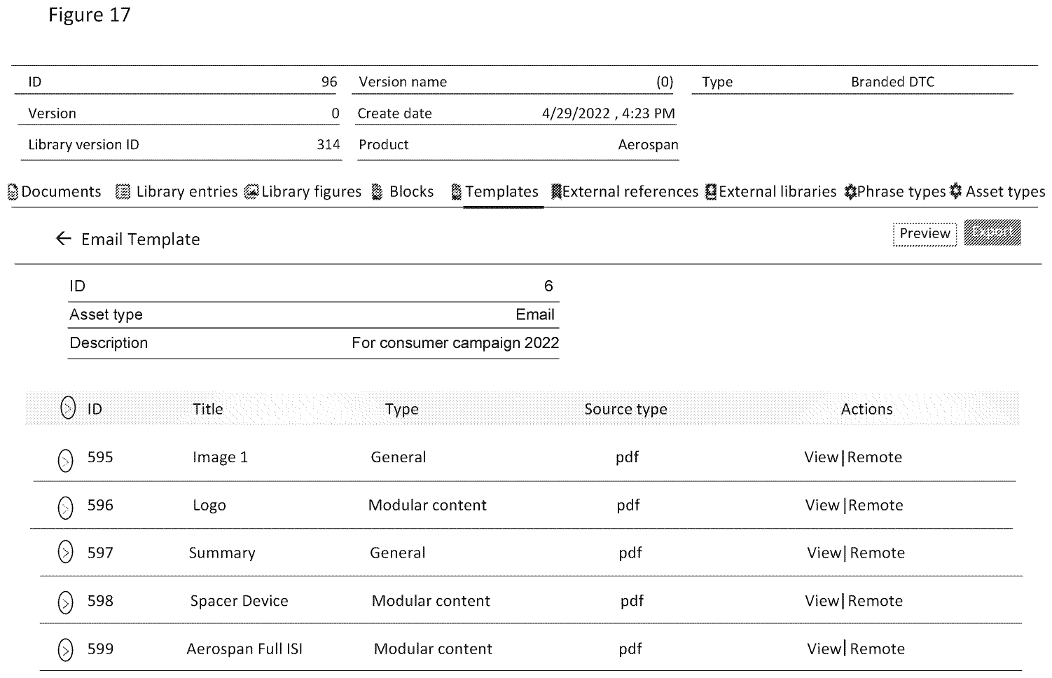

“Templates” each contain a list of blocks that should be in a document type, for example “email template” (e.g., as in FIG. 17) may have logo, summary, important information etc., each of which may comprise a “block”.

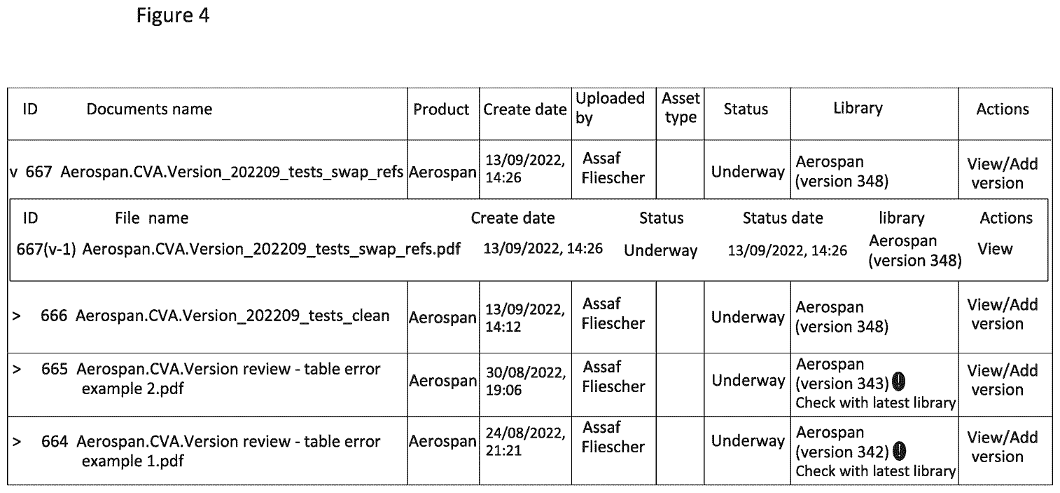

Library entries (e.g. as in FIG. 4) are defined as any text phrases entries appearing in the document/catalog whereas Library figures refer to catalog entries which are images (aka figures).

It is appreciated that Adobe InDesign is but one example of an authoring tool that may be used to generate new documents. The In-Design templates interface module allows the user to manage, edit, and apply libraries of InDesign (say) formatted content.

This functionality allows automatic application of specific content modification over multiple documents (such as company logo or drug indication).

This module typically includes all or any subset of the following functionalities/components:
aa. Importing Adobe-InDesign formatted files/documents (INDD file extension documents)
bb. Tagging specific content in these InDesign documents (this content can include content such as text/images/tables content) and using this tagged content to create a catalogue of InDesign content templates library
cc. Create and manage these libraries of modular content entries for each of these templates. Typically, each modular content item can include different textual or graphical sub-items
dd. Enable the user to define changes to a specific item
ee. Apply these changes across multiple documents which include this item
ff. Export these updated INDD InDesign files
The above functionalities aa-ff are now described in detail, according to certain embodiments:

### aa. Importing Adobe-InDesign Format Files/Documents

This may be done e.g., by applying an Adobe-InDesign functionality to export each document as a formatted XML data structure. This document XML data structure can then be imported into the system database.

### bb. Tagging Specific Content in These InDesign Documents

Inserting modular content “tagging” inside each InDesign document may be applied by a background built in tagging functionality in InDesign. A specific tag is inserted in the InDesign document to mark relevant content. These tags are not visible to the user in the displayed document, but enables the system to locate specific content.

### cc. Create and Manage Libraries of Modular Content Templates

The system typically stores these modular content templates in a specific DB table. This allows the user to view, create, and apply changes to these modular content templates.

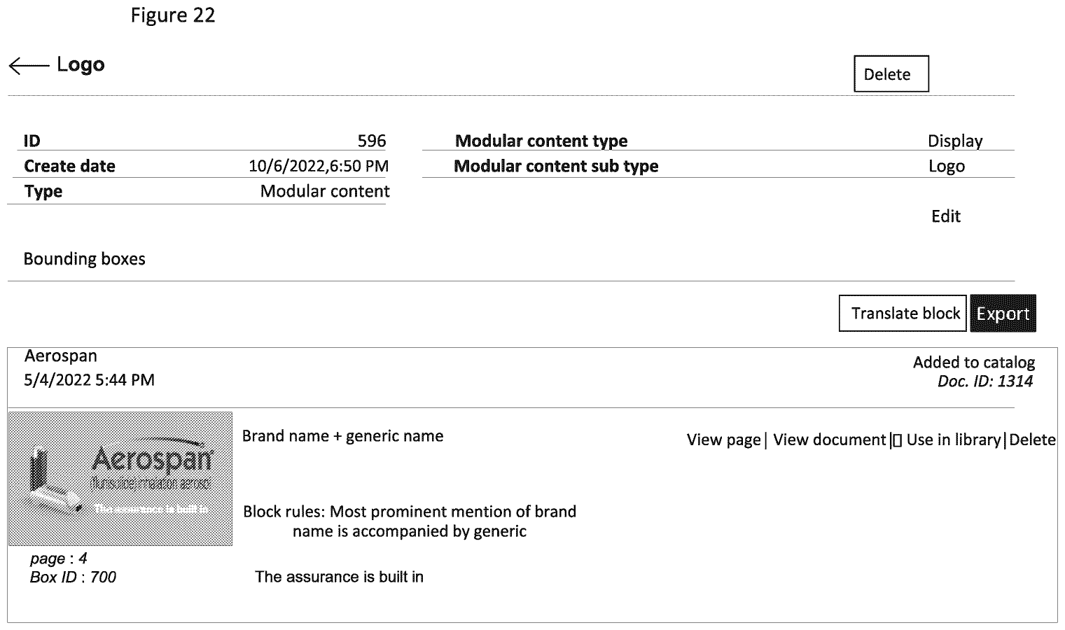

FIG. 22 is an example of a selection menu for modular content templates.

### dd. Enable the User to Define and Apply a Change to a Specific Item

Each item in the list can be modified (by replacing the text/image in this item).

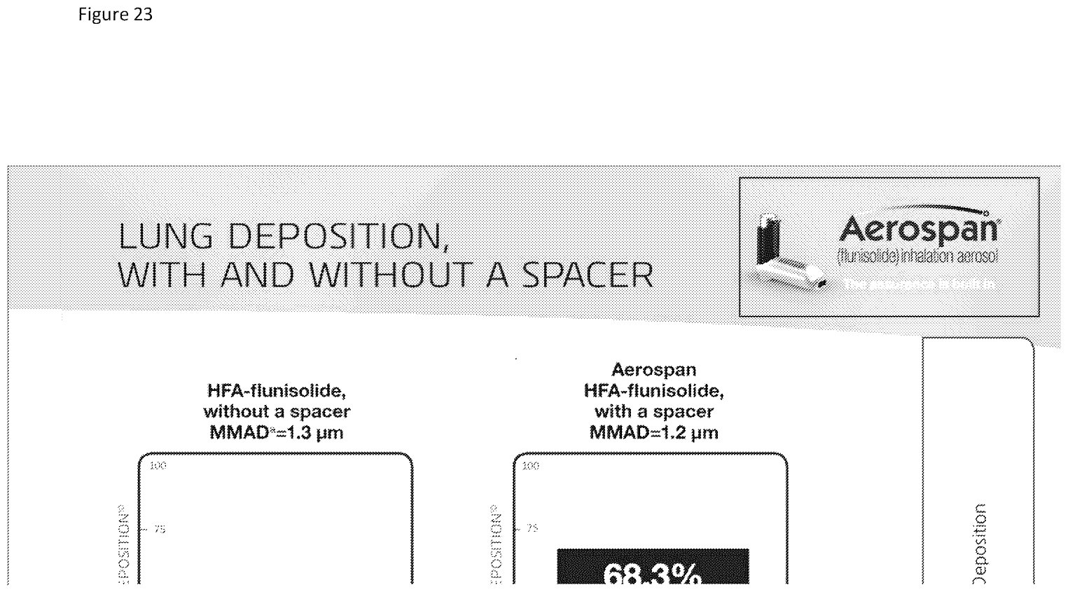

FIG. 23 is an example of a display window for a specific modular content template.

### ee. Apply Changes Across Multiple Documents Which Include This Specific Modular Content

Once the user defines a change in one of the items in the list, this change can automatically be applied across all documents which include this content and can easily be updated in all the appropriate InDesign documents).

### ff. Export the Updated InDesign Files

After the content modification has been applied to all the relevant documents, these updated InDesign document INDD files can then be automatically exported, to be used by the design team.

gg. document table extraction According to certain embodiments, a table extraction and validation module provides the user with various tools or features or functionalities to extract, manage, and validate document content which in the form of tables.

This process is typically performed both during the catalog creation process and/or during the review process, typically both.

These main functionalities may include all or any subset of:
i. Identifying and extracting any tables data in the document during processing.
ii. Creating and managing a catalogue (“dictionary”) of user pre-approved tables.
iii. Scanning a new document and matching the document tables to the table catalogue.
iv. Supply the user with a list of:
   pre-approved tables (part of the catalogue) appearing in the reviewed document
   new tables which are not yet part of the catalogue.

Identifying tables in the document may use machine learning to identify regions in the document which contain table type content. This process may use machine learning and deep-learning algorithms including visual recognition and textual recognition tools to enable them to identify any part of the document which might contain content in the form of tables. These deep-learning algorithms may be pre-trained over a dataset containing, say, thousands of documents. Suitable training datasets are available online, such as—Layout-Parser and typically include a list or set of pdf or image format manually pre-labelled documents, each document with a list of x,y coordinates for regions in that document which were labelled as text/image/table/list region.

The output of the table identification may comprise the coordinates (e.g., bounding boxes) of each of the tables which was identified in the document.

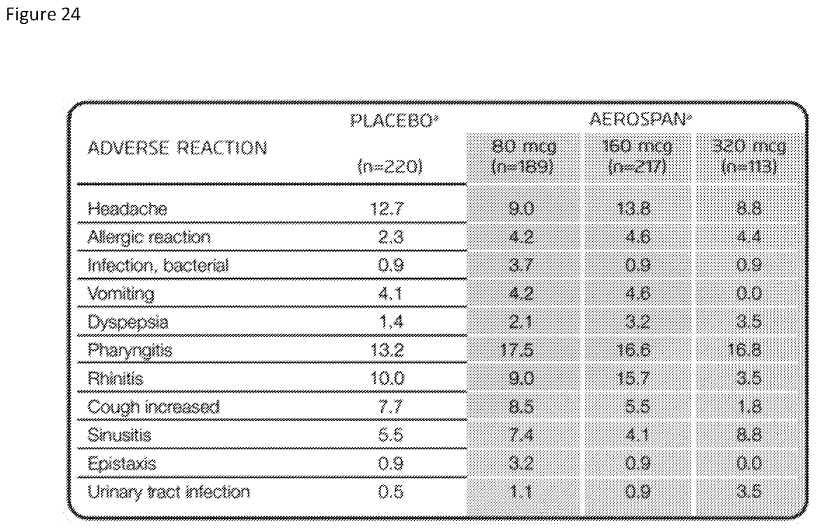

FIG. 24 is an example of table region identification, the identified table region being marked with a black rectangle.

Extracting tables data may comprise, for each part of the document which was previously identified as a table, extracting and processing actual table data, for storage in its correct ‘natural’ columns/rows structure e.g. using a python library named “pdfplumber”.

[‘Adverse \nReaction’, ‘NEXVIAZYME\n(N=51) n (%)’,
‘ALGLUCOSIDASE ALFA\n(N=49) n (%)’]
[‘Headache’, ‘11 (22%)’, ‘16 (33%)’]
[‘Fatigue’, ‘9 (18%)’, ‘7 (14%)’]
[‘Diarrhea’, ‘6 (12%)’, ‘8 (16%)’]
[‘Nausea’, ‘6 (12%)’, ‘7 (14%)’]
[‘Arthralgia’, ‘5 (10%)’, ‘8 (16%)’]
[‘Dizziness’, ‘5 (10%)’, ‘4 (8%)’]
[‘Myalgia’, ‘5 (10%)’, ‘7 (14%)’]
[‘Pruritus’, ‘4 (8%)’, ‘4 (8%)’]
[‘Vomiting’, ‘4 (8%)’, ‘3 (6%)’]
[‘Dyspnea’, ‘3 (6%)’, ‘4 (8%)’]
[‘Erythema’, ‘3 (6%)’, ‘3 (6%)’]
[‘Paresthesia’, ‘3 (6%)’, ‘2 (4%)’]
[‘Urticaria’, ‘3 (6%)’, ‘1 (2%)’]

The above is an example table structure extracted from the table sub-image and applying the “pdfplumber” module.

Matching and comparing document tables to a pre-approved table catalogue may comprise scanning and comparing each of the identified tables in the document against all of the pre-approved tables stored in the catalogue. This is implemented by computing a similarity score.

A tables similarity score for the two tables (catalogue and document) may be computed by using the following table features:
comparing the table structure (number of cols/rows)
comparing each axis heading (e.g., rows and cols names)
comparing number of matching rows data
comparing total number of identical cells between the two tables

Matching and comparing document tables to a pre-approved table catalogue may not be performed. Typically, after tagging and comparing the document tables to the tables in the catalogue, each of the document tables is classified in terms of their extent of match to the catalogue e.g., as-
Pre-approved tables: tables for which there is an exact match to a catalogue table (e.g., exact catalogue match, similarity=100%)
Tables for which a similar catalogue table was matched with some variations) (e.g., partial catalogue match, similarity over threshold e.g., between 50%->100%)
Tables for which no catalogue table match was found. (e.g., no catalogue match, similarity under threshold e.g., <50%)

An example flow (aka main flow) employed by the system herein is now described; all or any subset of the stages and operations may be performed in any suitable order e.g. as follows. The flow may include all or any subset of the following, suitably ordered e.g., as follows:
Stage I—Define users and environments; and/or
Stage ii—Create product catalogue; and/or
Stage iii—Review a document using an existing catalogue

These stages, according to certain embodiments, may respectively include the following operations, all or any subset thereof, suitably ordered e.g., as follows. It is appreciated that any module, functionality or embodiment described herein, or any conventional technology known in the art, may be employed to implement any of the operations below.

First, for illustrative purposes only, screenshots from an example system are provided in FIGS. 1-31. Specifically:

FIG. 1 is a Stage I screenshot which the system may use to define users and environments main menu—library/revise/label change/external libraries/user—manage-(users/environments/products/assets/tagged documents).

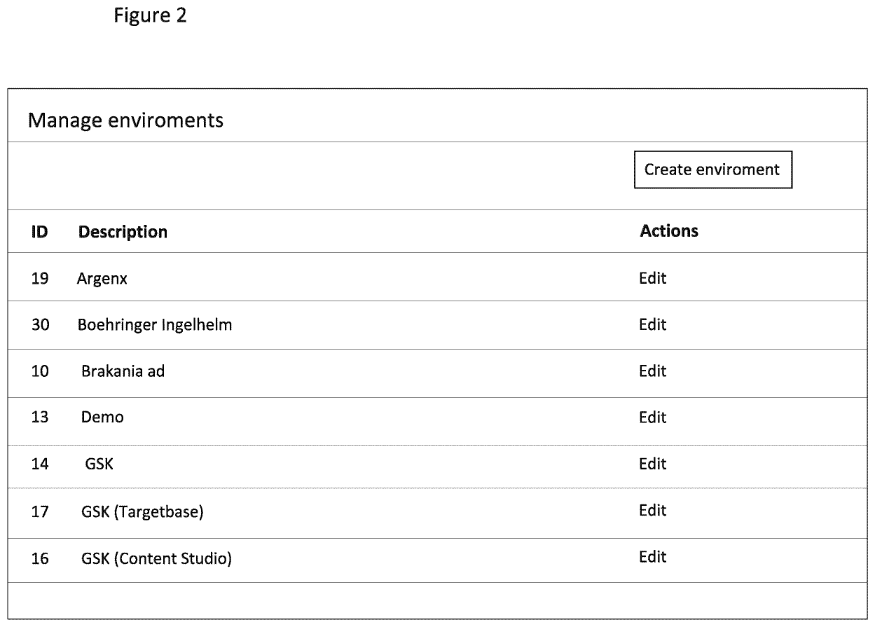

FIG. 2 pertains to the System user's environment and permissions management tool.

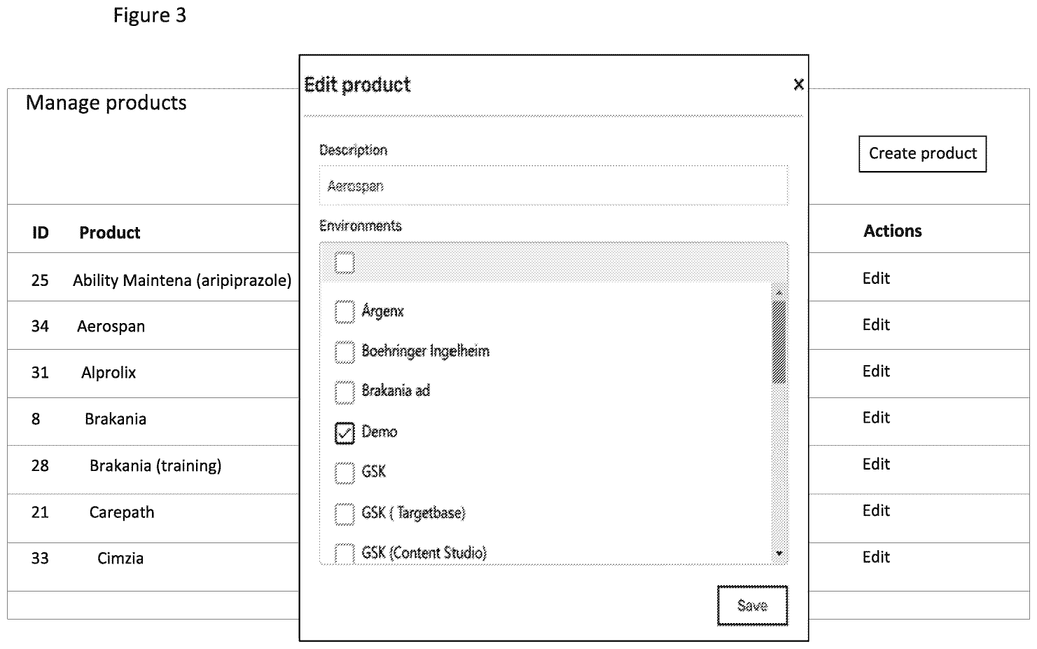

FIG. 3 may be used for Stage ii—Product catalog creation e.g. to edit product.

FIG. 4 may be used for Stage iii—Document review e.g. pertaining to document list.

FIG. 5 may be used for Stage iii—Document review e.g. to review main with top window.

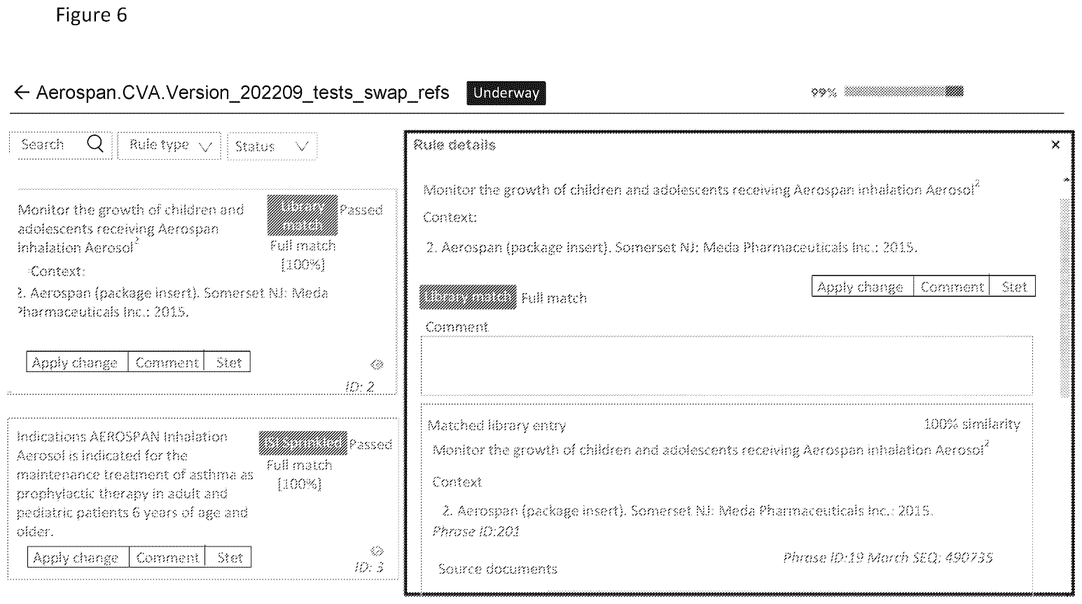

FIG. 6 may be used for Embodiment a8 e.g. with reference to phrase_main—rule.

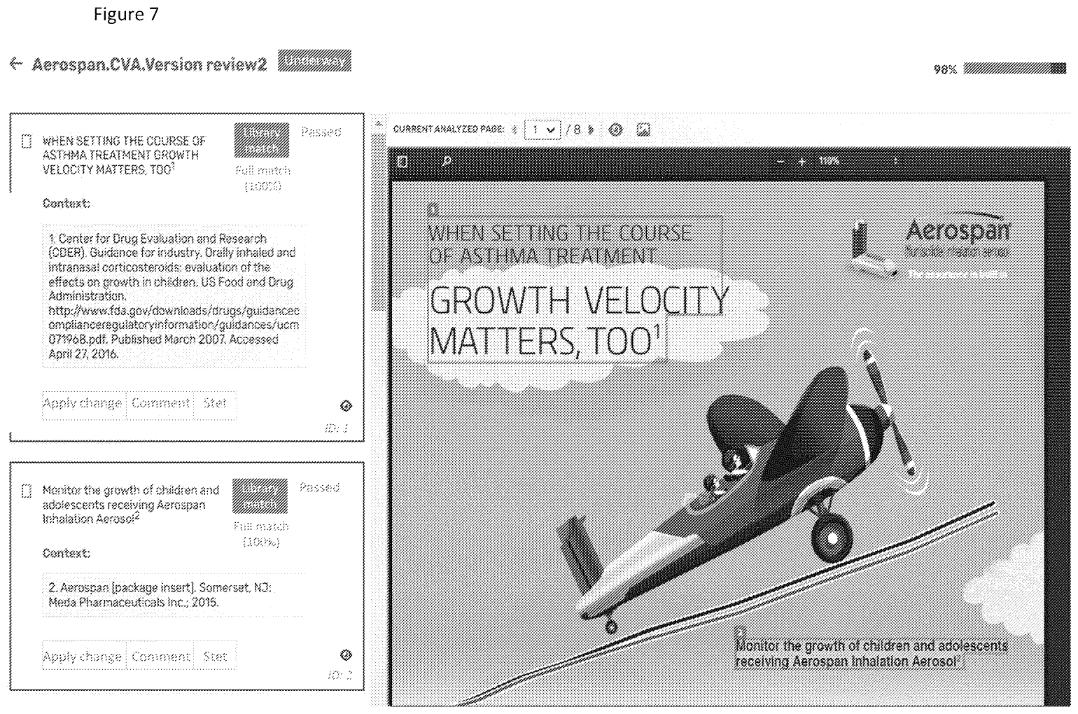

FIG. 7 may be used for Stage iii—Document review e.g. to review review main no top window.

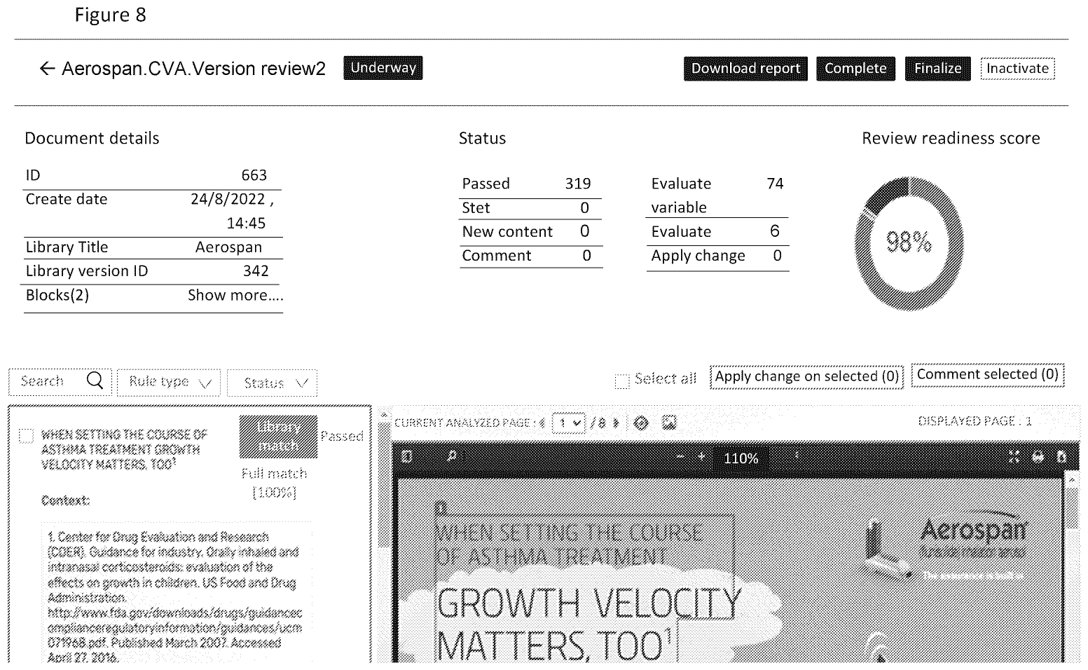

FIG. 8 may be used for Stage iii—Document review e.g. to review review main with top window.

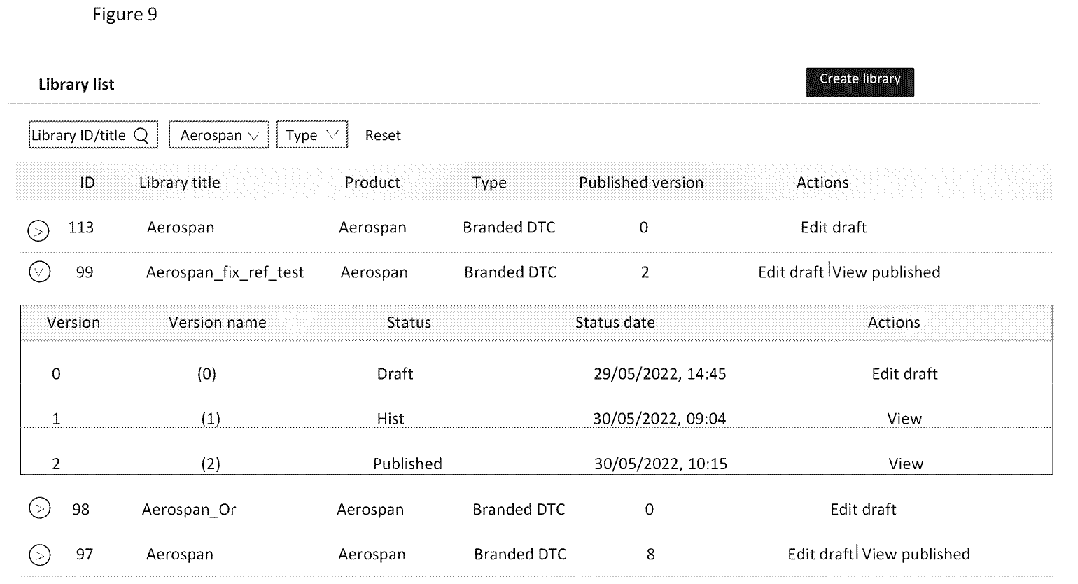

FIG. 9 may be used for j. Modular Content e.g. pertaining to library list.

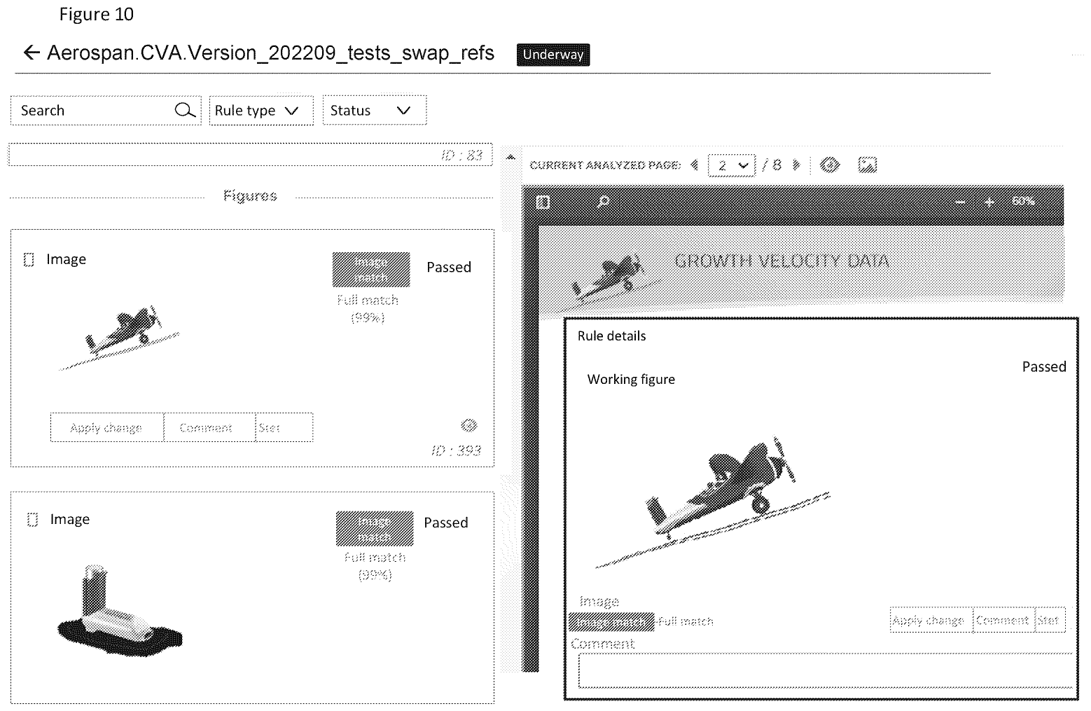

FIG. 10 may be used for Iii. Images content (e.g. as per functionality rule images.

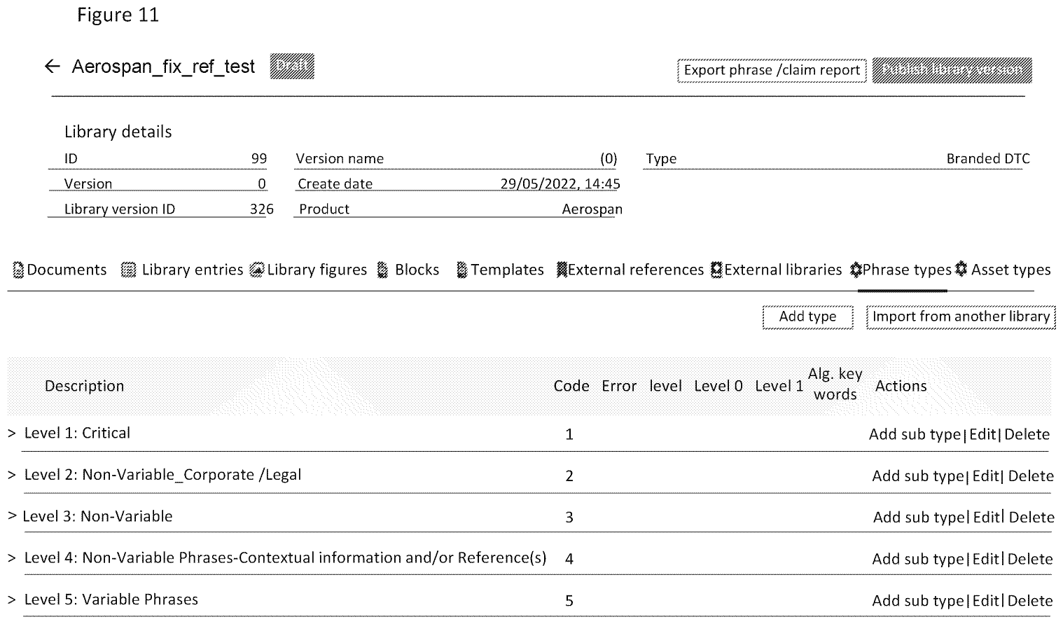

FIG. 11 may be used to classify document phrases into specific phrase types. phrase type level 1-5.

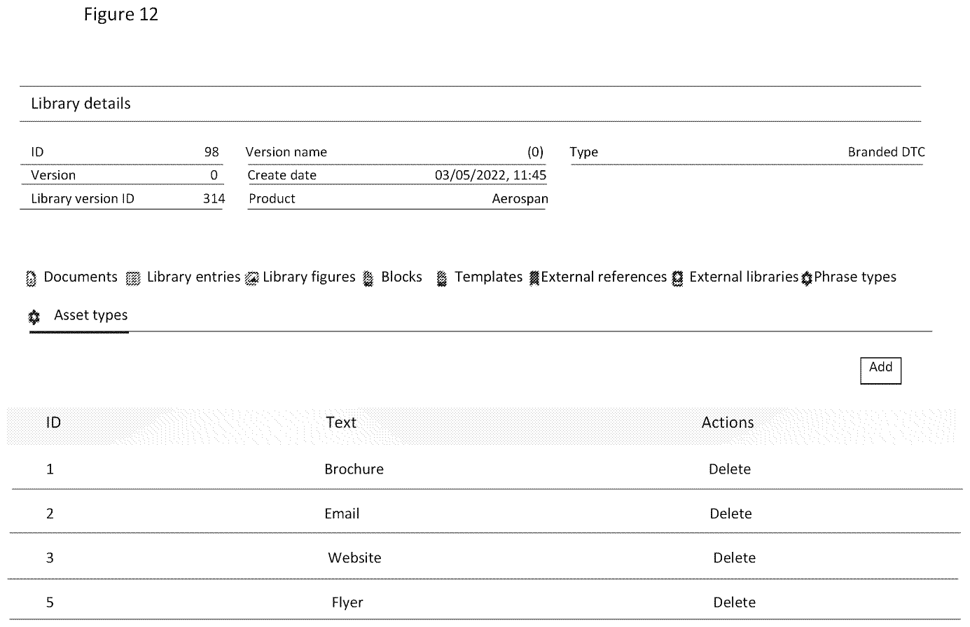

FIG. 12 may be used for modular content check e.g. for any of asset types—brochure/email/website/flyer.

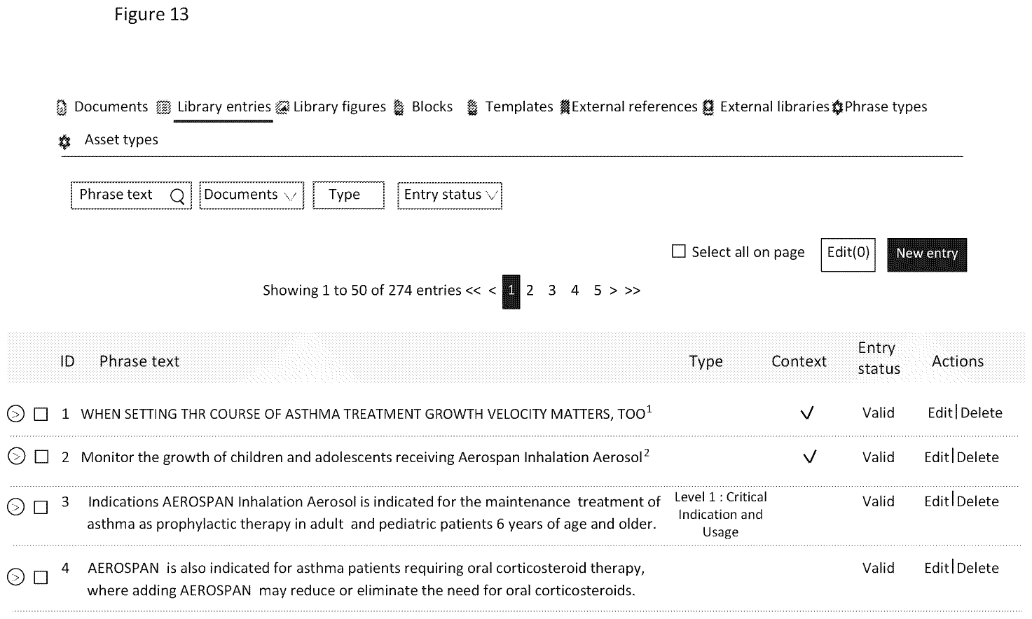

FIG. 13 pertains to library entries (text).

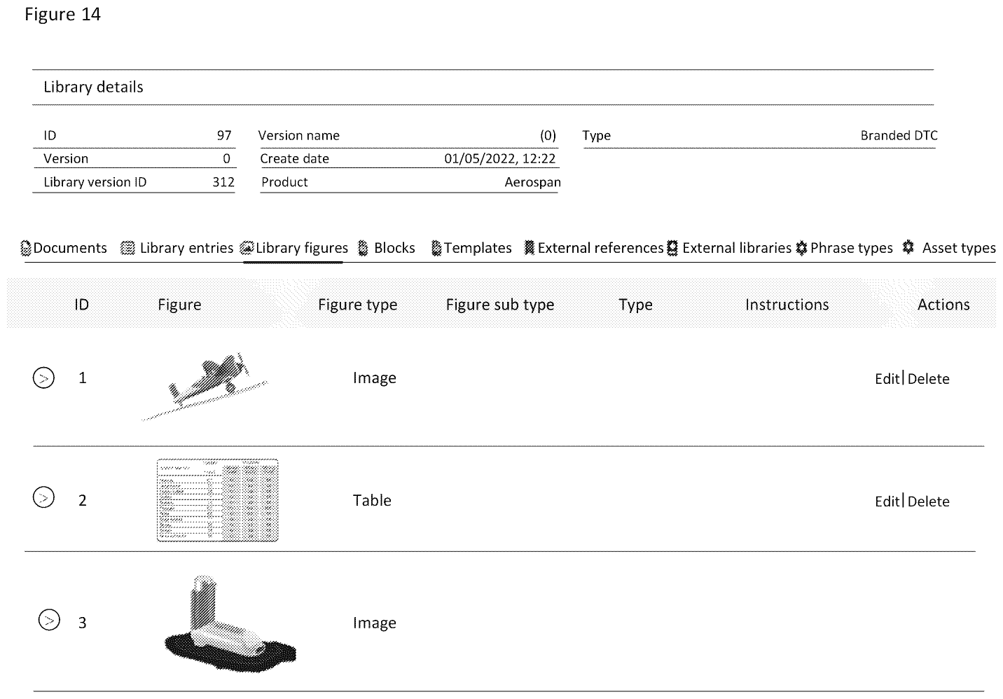

FIG. 14 may be used for Iii. Images content (e.g. for library figures.

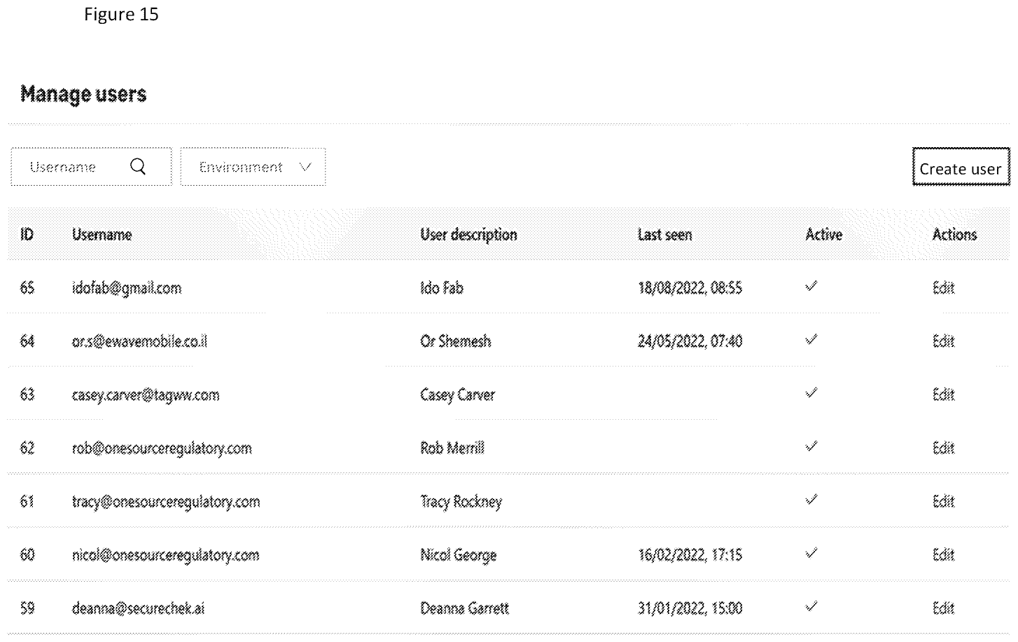

FIG. 15 may be used for Stage I—Define users and environments e.g. to manage users.

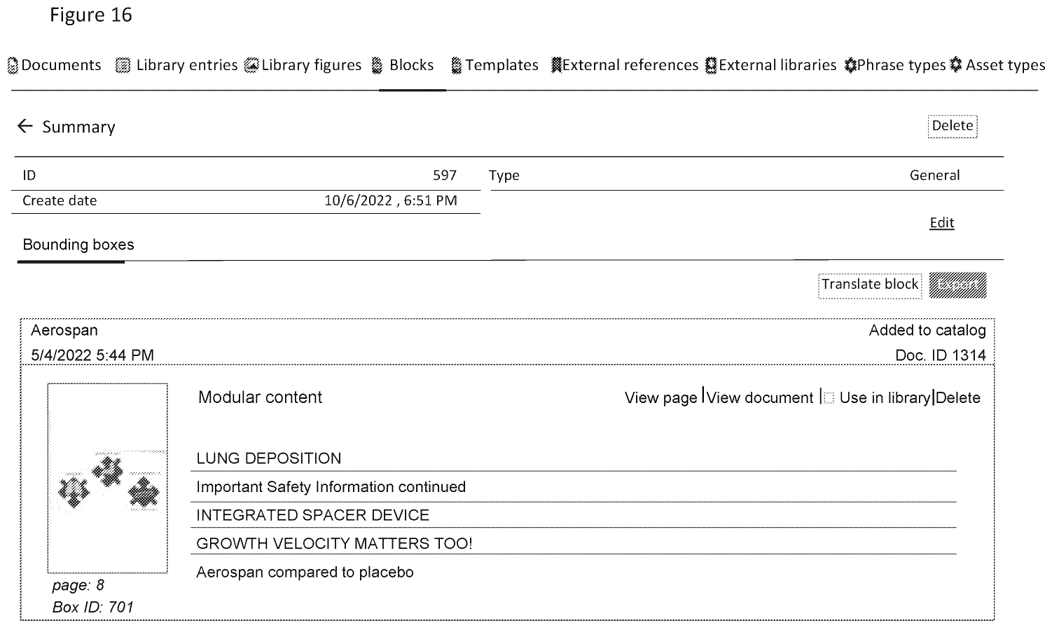

FIG. 16 may be used for functionality j. Modular Content e.g. to manage blocks.

FIG. 17 may be used for functionality j. Modular Content e.g. to manage templates.

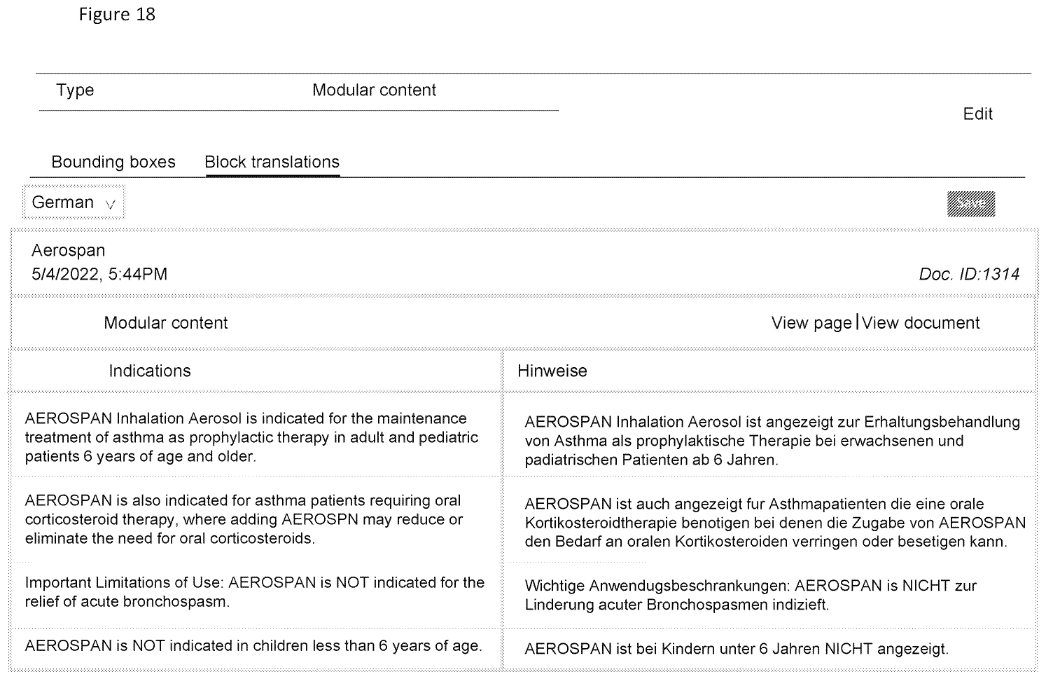

FIG. 18 may be used for functionality j. Modular Content e.g. for block translations.

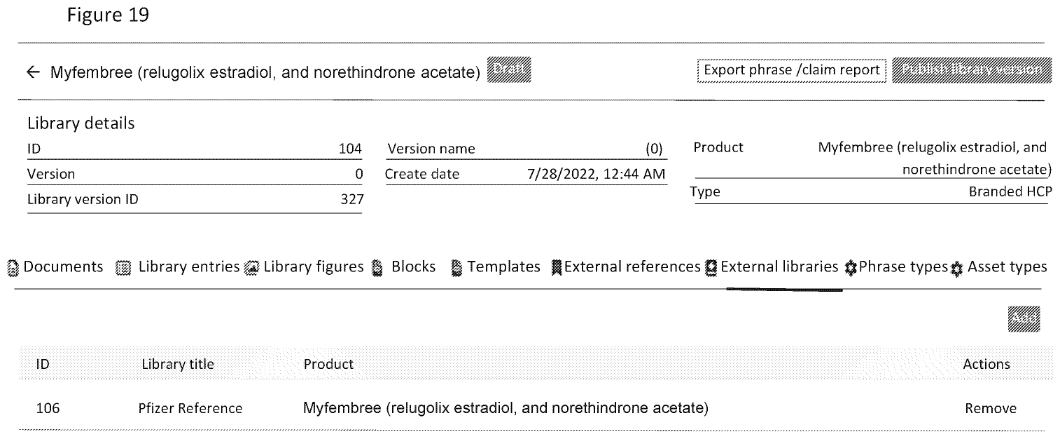

FIG. 19 may be used for operation 290 e.g. to check the document being reviewed includes all required references to external libraries.

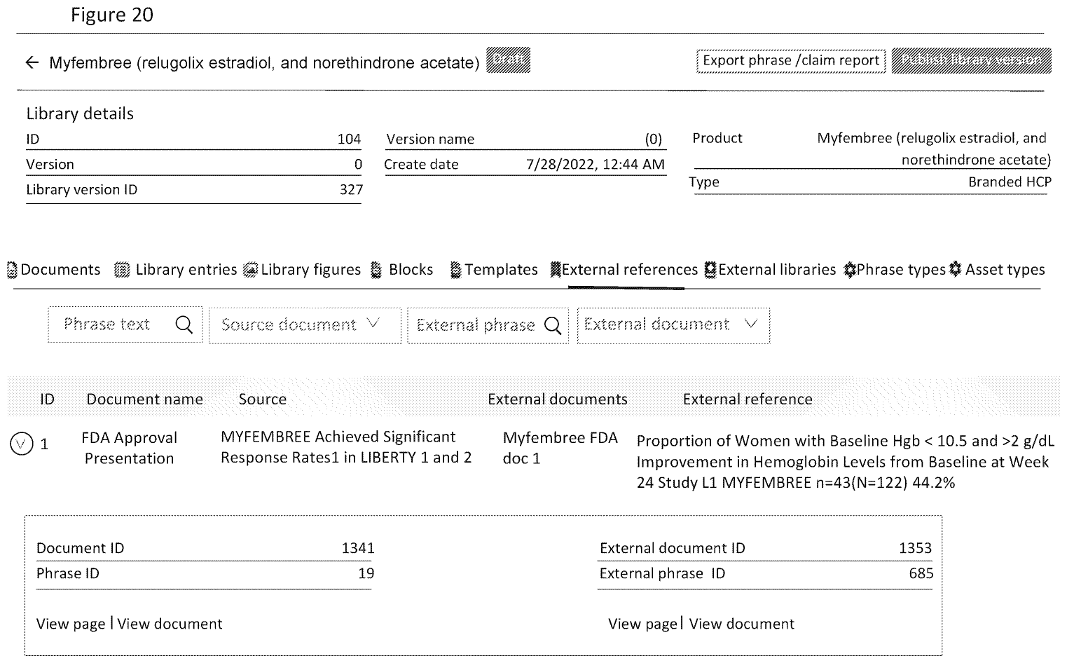

FIG. 20 may be used to analyze reference phrases e.g. for external references.

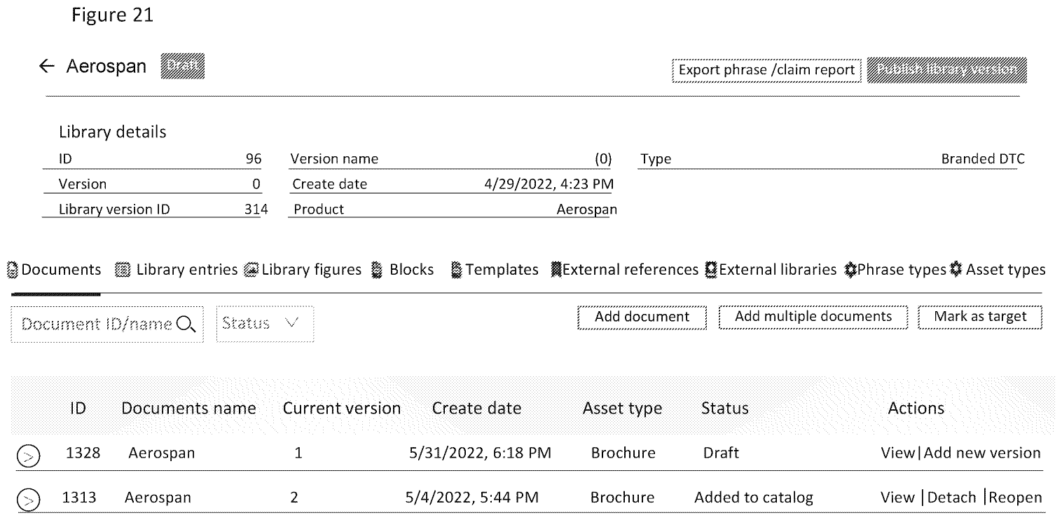

FIG. 21 may be used for Document reviewing and inspections tools (GUI) e.g. pertaining to documents list.

FIG. 22 may be used for bounding boxes.

FIG. 23 may be used for Stage iii—Document review e.g. pertaining to pdf view zoomed.

FIG. 24 may be used for operation 55 e.g. to identify and extract all images e.g. in a single image view.

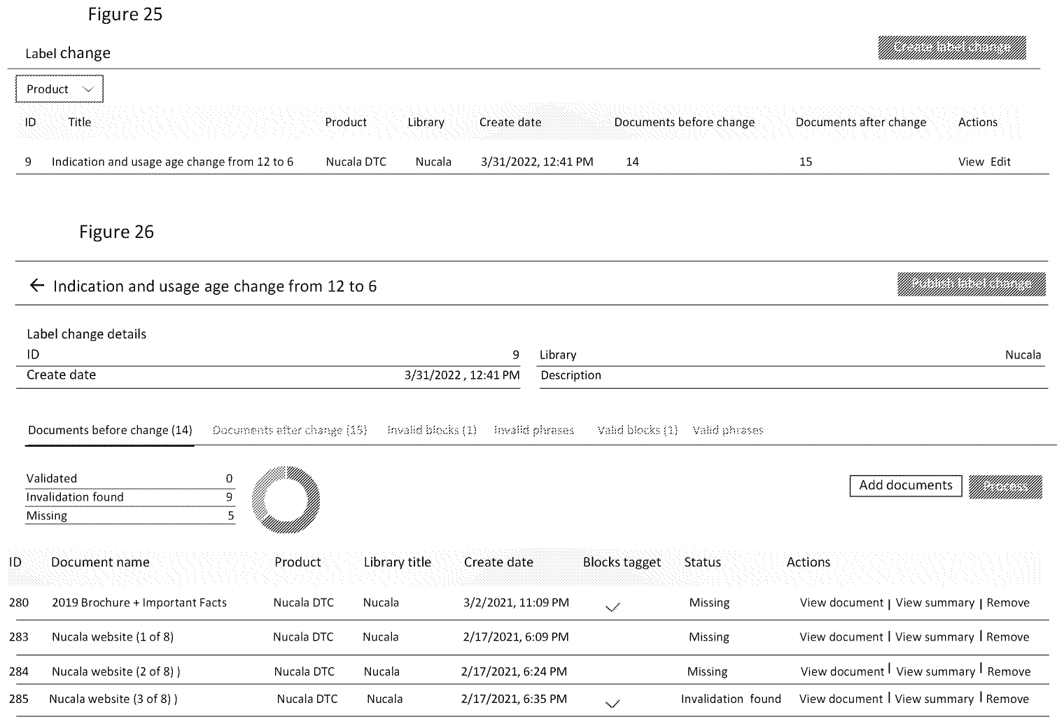

FIG. 25 may be used for functionality j. Modular Content e.g. for label change.

FIG. 26 may be used for functionality j. Modular Content e.g. for label change->documents before change.

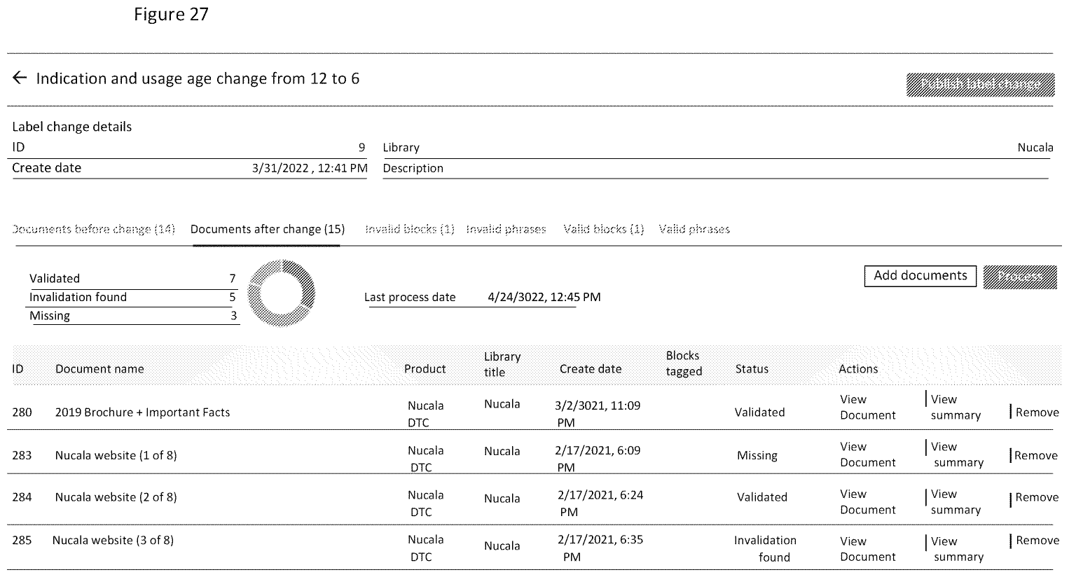

FIG. 27 may be used for functionality j. Modular Content e.g. for label change->documents after change.

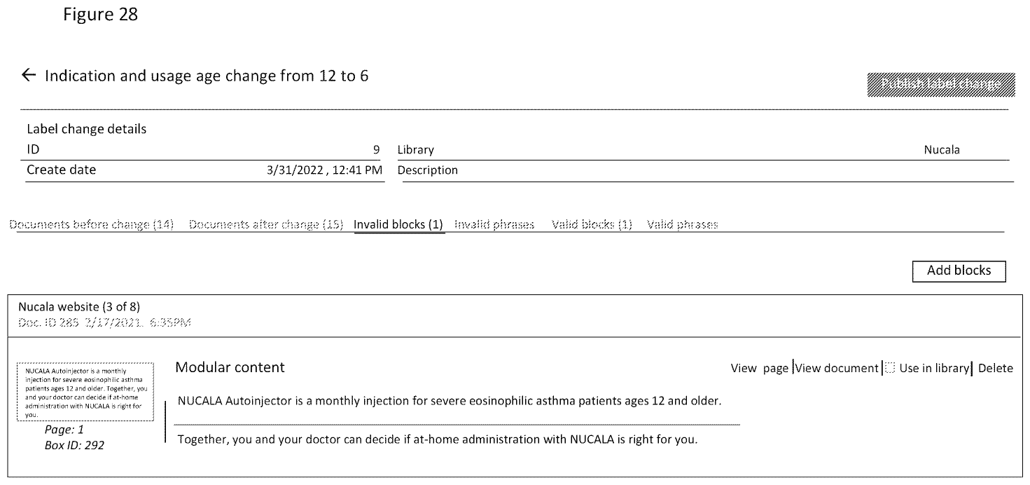

FIG. 28 may be used for functionality j. Modular Content e.g. for label change->invalid blocks.

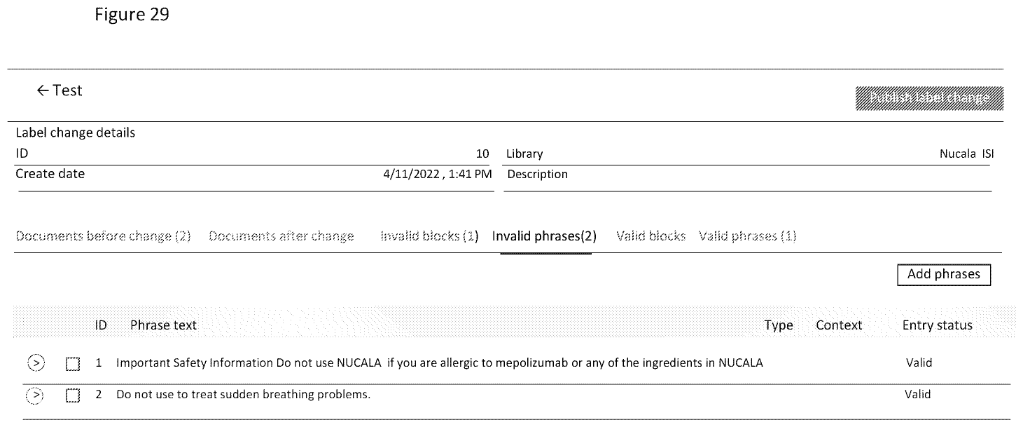

FIG. 29 may be used for functionality j. Modular Content e.g. for label change->invalid phrases.

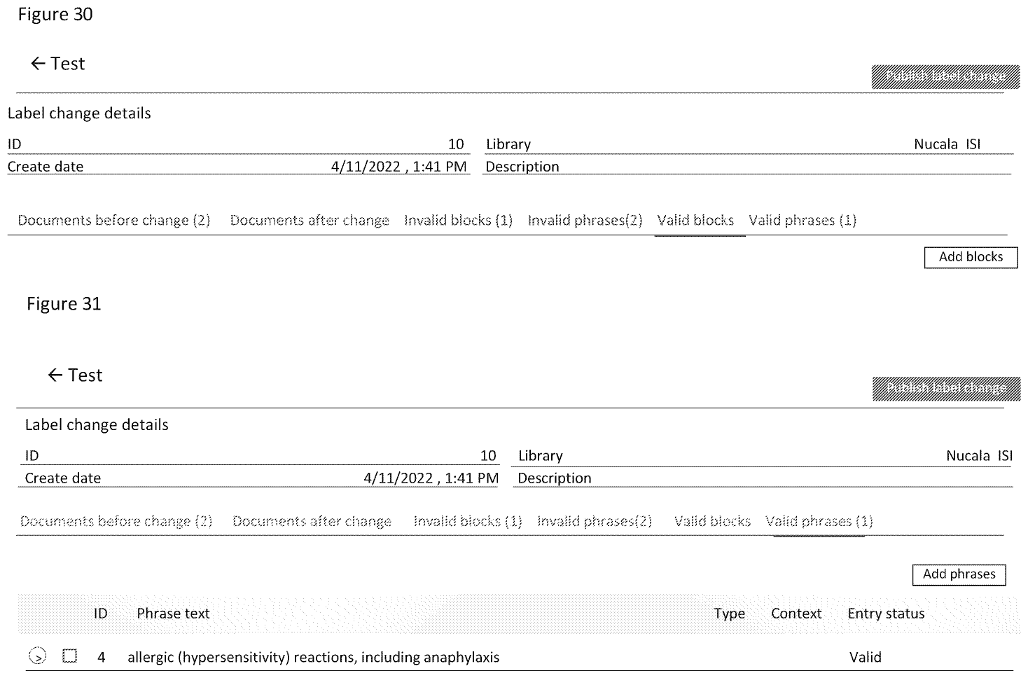

FIG. 30 may be used for functionality j. Modular Content e.g. for label change->valid blocks.

FIG. 31 may be used for functionality j. Modular Content e.g. for label change->valid phrases.

It is appreciated that the specific system whose operation may be appreciated from considering the above screenshots, is merely exemplary and is not intended to be limiting.

The system, then, may comprise a hardware processor/s configured to perform all or any subset of the following:

### Stage I—Define Users and Environments

Operation 10: Create system users, including defining permissions for each user and assigning general system user particulars, such as username, password, and email address.

Operation 20. Create a work environment for each product, in which a product catalogue will be created.

It is appreciated that two flavours of the same children's medicine, or the same medicine in two different packages or two different quantities (e.g., 12 vs 24 capsules or capsules vs liquid gels) may be defined as one product, or may be defined as different products.

Operation 30: Associate each user with the appropriate catalogues and review documents (aka new documents aka documents to be reviewed for compliance, typically with respect to an existing catalogue which may have been generated from a previous version of the new document). For example, if three users are representing manufacturer “a”, and seven users are representing manufacturer “b”, the system may associate the three with a's catalogues and the seven users with b's catalogues.

### Stage ii—Product Catalogue Creation: for Each Product, Create a Catalogue (aka Product Catalogue) Which Includes a List of Allowed/Approved Content)

Typically, reviewing/validation of a new document is only performed after a product catalogue has been created, from which catalogue the system defines valid content, according to which validation (including determining compliance) is performed.

The catalogue typically defines content (phrases images etc.) approved, during catalogue creation, by the user for validation of future versions, aka new documents.

Some content may be identified during a new document review process (which may be part of a new-document pre-check) which is not included in the existing product catalogue. Typically, this content is highlighted for the user to determine whether this is legitimate, intended new content, or wrong content.

Stage ii may include a flow for initial upload processing/parsing of compliant document/s which may include all or any subset of the below-described operations 40-90, which may be performed in any suitable order e.g., as follows:

Operation 40: Upload a single or multiple documents (e.g., pdf documents from a user's PCT) to the system. These are typically documents which are known/assumed to be compliant, which the system uses to learn how to review new documents for compliance.

The user can upload one or many documents, from which he would like to extract phrases to be added to the catalogue, e.g., because these documents contain (or at least partially contain) content which is known to be already valid/approved. Such content can be extracted from uploaded document/s manually reviewed by the user during the catalogue creation process and added to the product catalogue.

Operation 50: identify and extract all identified text, in the uploaded document/s, which appears in plain text format (as opposed to, say, text which is part of an image/is in graphics format).

Operation 55: identify and extract all images contained in the document including images in various formats such as but not limited to gif, JPG, Bitmap, vector maps e.g., Adobe drawing format.

Operation 60: Add images to an image list and/or save each as a separate image file

Operation 70: Each time there is textual/numeric data embedded in a given image (e.g., each time the image comprises a graph), extract the data in the graph (e.g., all or any subset of: x, y of each data point, horizontal and vertical axis names, title, and caption text).

Operation 80: Perform OCR (Optical Character Recognition) on each image in the document.

Operation 90: Combine ‘plain’ text included in the document, together with OCR extracted characters, to create a full list, aka character list, containing each character ASCII representation, page number, font size, font type, position, width and height.

Typically, the character list includes a list of all characters in the document, including all characters represented as text in the document, and all characters OCRed from document images, and, for each character, all or any subset of the following are stored: the character's ASCII representation, font size and type, the number of the page on which the character occurs, and the character's location or position on that page e.g. including the character's width and height, or horizontal and vertical locations on the page.

Operation 100: Use Word Parser for Word segmentation—scan the character list and identify character sequences which belong to the same word, thereby to generate a word list.

Operation 110: Use sentence parser to identify and separate the words list into phrases, or word sequences which are related to the same sentence or form a sentence.

Operation 120: Use a Tables Parser to identify any tables in the document, and, for each table, extract headers for each of the table's columns and rows.

Operation 130: Process textual data appearing in the table including saving the table's textual data in a per-cell formatted data structure.

Operation 140: extraction of document references
locate all reference starters and pointers in the document.
create a full list of references appearing in the document including matching reference pointers and starters.

Operation 150: Locate any horizontal/vertical item lists by identifying any parts of the document that contain numbered ordered item lists (Lists such as 1 . . . , 2 . . . , 3 . . . or (a) . . . , (b) . . . , (c) . . . ). Store these item list phrases in a dedicated, ordered data structure.

Operation 160: Extract Contact details e.g., by identifying and/or locating and/or extracting any Email addresses, or phone numbers appearing in the document

Operation 170: The user is prompted to designate any of the following extracted above: text sentences, images, table headers, table cells, references to external documents (aka document references), graphs, contact details, as approved for addition to the product catalogue which defines mandatory components of any new document. Responsively, system adds this user-defined mandatory (in all new documents associated with product) content to the product catalogue.

The terms “components” and “modules” may be interchanged herein, as may the terms “catalogue” and “library”.

Example: if the document's first line says “1 Apr. 2022” and the user approves that, the catalogue typically includes the text “1 Apr. 2022” (rather than “date”).

According to certain embodiments, the system presents the uploaded, wholly, or partially compliant document/s (e.g., pdf file/s) to the user, and asks the user to select what should be added to the product catalogue.

The system may render this process more convenient for the user by suppling the user with any suitable tools to perform this, such as all or any subset of:
a dedicated pdf-viewer, on which the user can mark the ‘approved’ content.
Auto segmentation of the content to phrases/tables/images etc.
Handling more complicated content such as external references, lists, tables e.g., as described elsewhere herein
The system may be configured to be tolerant to non-significant differences (page layouts, page layout etc)

### Stage iii—Document Review: Reviewing a New Document Using an Existing Catalogue

Operation 205: Upload, to the system, a single or multiple new documents which are to be reviewed for compliance (e.g., pdf documents from a user's PC)

Operation 210: Parse the new document using all or any subset of operations 50-160 above

Operation 220: Match phrases to catalogue phrases, typically including matching each of the document phrases, to existing identical catalogue phrase e.g., by finding similar catalogue phrases, and, from among these, identifying an identical phrase, if any.

After finding the “most similar” catalogue entry, the system compares the document vs this catalogue entry, and finds the most similar catalogue phrase in the product catalogue.

The terms “entry”, “content entry”, and “catalogue entry”, may be used interchangeably herein, and may be used as a general term for phrases/images/tables/graphs which are included in the product catalogue, hence are manually approved as allowable, although not necessarily mandatory, in any new document associated with this product.

A phrase may be considered “most similar” if the phrase is the most “similar” existing or pre-approved catalogue phrase included in the product catalogue or the phrase which was already previously included/approved/added to the catalogue by the user. Typically, for each phrase P in the reviewed document, the system determines which entry or phrase in the catalogue, is most similar to P.

The system then identifies any differences (e.g., extra/missing/changed words) between the document phrase P and this “most similar” catalogue phrase.

Operation 230: The system may suggest content additions/modification/deletions, where required. This process may rely on stored data which maintains the most probable rearrangement of the reviewed vs catalogue phrase words. Thus, the system may, e.g., after finding the most similar catalogue phrase, also find the most probable way (e.g., least number of modification/resorting) to re-arrange the reviewed phrase P vs this most similar catalogue phrase.

This may include tagging each word in the reviewed and matched catalogue document phrases as an extra/missing/changed word vs. a word that exists in the catalogue. The output of this process typically allows the system to visually display a comparison text, which highlights a match/extra word/what is missing per each word. This may rely on stored data maintaining the optimal word sort order between the review phrase P and the catalogue phrase most similar to P.

Operation 240: compare set or sequence of phrases in the document to be reviewed, to a matching set or sequence of phrases in a catalogue, to yield a set of entire phrases in the new document which are extra/missing (e.g., are in the new document but not in the catalogue, or vice versa)

Operation 250: Classify each phrase in the document being reviewed, to a specific content type, such as Safety information/Indications/Contraindications etc. One content type may be “other”, so that phrases not classified to any other content type, may be classified as “other”. To do this, a classifier may be used which was previously trained over a known labelled list of phrases. And/or, a manual classification scheme may be employed, by finding a similar/identical phrase that was previously manually classified as belonging to (say) content type A e.g. indications, and matching the current phrase in the document being reviewed to content type A, as well. Such a phrase may be found, for example, by scanning through existing catalogues and documents which were already checked, and locating a similar/identical phrase that was previously manually classified as belonging to (say) content type A e.g. indications, and matching the current phrase in the document being reviewed to content type A, as well.

Operation 270: check that the document being reviewed contains all content defined as required, in the product catalogue aka “modular content catalogue” which may include textual data that is mandatory, aka required in all new documents, and/or mandatory phrase sequences, and/or mandatory images/tables/graphs and/or textual data that is allowable in all new documents, and/or allowable phrase sequences, and/or allowable images/tables/graphs and/or non-permissible textual data that is not permitted in new documents, and/or non-permissible phrase sequences, and/or non-permissible images/tables/graphs.

Operation 280: Check that phrases in the document being reviewed appear in a correct order pre-defined, in the product catalogue, for (at least) mandatory catalogue content phrases

Operation 290: Check the document being reviewed includes all required references to external documents, e.g., by checking that the document includes all such references defined as required in the product catalogue

Operation 300: Check the document being reviewed includes all mandatory tables e.g., by checking that the document includes all tables defined as required in the product catalogue

Operation 310: Check the document being reviewed includes all mandatory images e.g., by checking that the document includes all images defined as required in the product catalogue

Operation 320: Check the document being reviewed includes all mandatory graphs e.g., by checking that the document includes all graphs defined as required in the product catalogue

Operation 325: Check that the content included in each table, image and graph therewithin) matches exactly to the content as defined in the catalogue (e.g., exact matching content of corresponding table, image and graph in the catalogue)

Operation 330: Compute ‘match score’ and additional review of KPIs including all or any subset of:
a. Number of phrases marked as “passed/stet//evaluate variable”, where “stet” and “evaluate variable” both refer to a phrase that still needs to be evaluated by the user as statements/phrases/sentences that can be considered as valid/allowed/legal statements and are allowed to be included in the reviewed document

These matching process statistics are then shown to the user during the process of reviewing the pre-checked document.
b. Number of phrases manually marked, by a user, after the user reviews system results; these results may be shown during the pre-check process as “apply change/New Content”.
c. Review-readiness score (e.g. 0-100% general score) including the % of phrases/images/tables/graphs/references in the document being reviewed, which were successfully matched to corresponding phrases/images/tables/graphs/references respectively, in the catalogue.

Operation 340: Create summary report for the user e.g., by exporting all information extracted in operations above to a single pdf summary report document, which may include all review statistics, aka document KPIs, aka Key Performance Indicators computed in operation 330, and/or detailed review results, typically per phrase, typically including an indication, for each phrase, of whether a catalogue match was found.

The main flow may be characterized by, or include, all or any subset of the following novel features and operations and functionalities a, b, . . . :

a. Text parser—operations 100 and 110 which is configured to process a pdf file, and arrange characters/words/phrases in their correct reading order (e.g., “human-like” reading order), including operations 100, 110.

In characters-to-words operation 100 (aka “functionality b”), the system connects separate chars to words, by scanning the text character by character, including deciding what is the following character in the text, and whether this character is a part of the current word, or whether it belongs to a new word. Typically, the text is scanned from the char list described above which typically includes both alphanumeric characters and spaces.

Although the next char is typically the first char to the right (for English, or opposite for languages such as Hebrew), the logic may also employ considerations such as:
How far to the right is the next word char candidate?
(e.g. is there a new word space separator).
What is the vertical alignment of the next char candidate? (e.g., account for superscript/subscript cases, or imperfectly aligned text).
Does the next char have the same font type, and font size?

Example logic: Define word break by iterating over all chars scanned from the char list and defining a word break each time one of the following (or one of any subset of the following)=true:

• The last char is a space char
• The last char contains control characters such as = [‘.’, ‘?’, ‘!’, ‘...’]
_AND NOT part of UrL/email/decimal number
• the next char is in a new page
• the next char font type is different
• the next char font size is different than the previous above a certain
threshold
• The next char is above a certain distance in x from the last char
• The next char is above a certain distance in y from the last char
• Store as a new word, if the non-space chars in the sequence above
length >0

In words-to-phrases operation 110 (aka “functionality c”), logic may be developed for connecting word sequences into sentences.

Example logic: iterate over all words identified in operation 100 and define phrase break each time one of the following (or one of any subset of the following)=true:

• The last word last contains control characters such as = [‘.’, ‘?’, ‘!’,
‘...’]
• the next word is in a new page
• The next word is above a certain distance in x from the last word
• The next word is above a certain distance in y from the last word

This logic may be implemented or varied relying on various considerations such as:
whether there is a period, or a question mark, between the words.
The horizontal and a vertical location of the next word—e.g., is the next word to the right, or is it in a new line? If it is in a new line, is it in the same horizontal location as the start of the last phrase start?
Is there a line break (line break ascii char) between words?

### d. Per WORD Doc vs Catalogue Phrase Difference—Operation 220

In operation 220, typically, the catalogue matching process requires comparison of two text segments. This matching process typically has enough robustness to find similarities between two texts which can have a relative shifted, re-arranged word order, or only partial similarity. Typically, a similarity score is generated; the system may compute the minimum number of permutations required to transform text1->text2. The output of this is then converted to a similarity score which may range from 0->100%. The system may perform, per word, exact mapping of the document and the catalogue texts to identify extra/missing/swapped words, so each scanned word from text1 is “mapped” to its relative location in text2 maintaining the correct word order, and each word is tagged as either matched, missing, or extra word.

Example flow may include all or any subset of the following processes, suitably ordered e.g., as follows:

• Iterate over the document phrase words -

| ∘ | iterate over the catalogue phrase words | |
|---|---|---|
| | § | clean all reference chars from catalogue and phrase word |
| | § | if the catalogue word and the phrase word are identical, : |
| | | • advance tmp1 max found number of sequence |
| | | matching words in 1 |
| | | • move to the next word both in catalogue and |
| | | document phrase |
| | § | else: |
| | | • check if tmp1 max> tmp2 max if so set temp |
| | | max found number of sequence tmp 2 max = tmp1 |
| | | max |
| | | • set temp 1 max found number of sequences to |
| | | zero |
| | § | next catalogue word |

| | |
|---|---|
| ∘ | move to next phrase word. |

• Output : tmp2 max (value and relative location found in phrase)

### e. Phrases Classification e.g., as Per Operation 250 in the Main Flow

Each phrase/sentence extracted from the document is typically classified into a defined type of phrases, (for example: safety information, indications, dosage etc.)

This classification may combine two criteria:
If the phrase already appears in the catalogue, or in an earlier new document previously checked for compliance using this same catalogue that the system is now using for some later new document, and was previously classified and approved manually, the scanned document phrase is classified the same as the catalogue phrase matched
Using a text classifier, which applies matching keywords, and word sequences, to find the optimal match between phrase/sentence and phrase type.

The classifier may be trained over data taken from a database of existing manually approved classified phrases. Thus, to train this classifier, training data to use may include keywords and word sequences which were tagged, e.g., by humans as belonging to certain phrase-types, aka classes, such as safety information, indications, and dosage.

The classifier uses key words frequency features. For example, the pre-training of this classification (training of the classifier) may include counting relative probabilities of different words, for each different phrase types (class) so as to generate a bag-of-words, for example:
Phrases which are “Important safety information” type phrases, typically have higher probabilities for word sequences such as—“PLEASE REVIEW”, “Do not”, “warning” etc. . . . .
Phrases which are classified as “indications” are more likely to include words/sentences as “is indicated”, “age or older”, “treatment” etc. . . . .

### f. Image Matching

In order to facilitate comparison between images in a scanned document vs. images that are already stored in the catalogue, three different image segmentation/registration methods f1, f2, f3 may be applied:

### Method f1 for Operation 55

Extract “plain” images (e.g., images which are stored in the pdf document with their original PNG/GIF/BMP format).

### Method f2 for Operation 55

Extract images e.g., using a “layout parser’ algorithm which uses statistical Machine Learning to identify regions in a document page and to classify them according to type of content: text/image/graph/table.

### Method f3

Machine learning based process to compare and match the images in the scanned document vs catalogue images. This is applied by comparing each document image to each catalogue image. Each iteration of the document image is registered to the catalogue image e.g. using SIFT (Scale-invariant feature transform) image registration. After performing this registration, a number of image similarity scores are computed.

These image similarity scores may include all or any subset of:
subtraction of the transformed document image followed by computing the normalized absolute sum over all pixels of the subtraction image
registration quality score using the number and weight of the features returned from the image's registration process
Color histogram comparison
OCR image to text on the image, and comparing the catalogue image text to the document image

It is appreciated that the main flow may include an operation 55 for identifying and extracting the images from the document (e.g., finding a location in the document that includes images/) and/or an operation 310 for comparing each of the images extracted from a new document, to each of the existing images in the catalogue, and matching new document images to catalogue images.

Method f3 may be used for operation 310 and/or for initial locating and extracting images (operation 55), during document parsing, since one way to determine whether an area in the document is an image, is to try to match that area or region of the new document, to the various catalogue images, and determining whether any of the catalogue images is similar to an over-threshold extent to the document area being examined.

Methods f1, f2, f3 are configured to find, or locate, or segment, or provide registration of all the images in the document.
These methods may for example be performed as follows:
Method—f1 Extract “plain” images:
These images are extracted using a python pdf reading library named PyMuPdf. (This is the same library as the one used in order to extract ‘plain text’ parts from the pdf).
These images are embedded in the pdf as an external ‘attachment’ (are stored in the pdf document with using an image type such as PNG/GIF/BMP format).
Method—f2 Extract images using “layout parser’ library:
Extract images e.g. using a “layout parser’ algorithm which uses statistical Machine Learning to identify regions in a document page, and to classify them according to their type of content-text/image/graph/table
LayoutParser is a Python library that provides a wide range of pre-trained deep learning models to detect the layout of a document image.
The layout parser' library was pre-trained over multiple documents to be able to segment an input image to sub-regions, and to classify each of these regions as text/image/table/list.
Method—f3 Extract images by locating catalogue images in the documents:
This method typically uses SIFT (Scale-invariant feature transform) image registration. For each existing image in the catalogue:
The method typically performs image registration (e.g tries to find/project the catalogue image to the document. After this registration is done, the following techniques may be used to evaluate the registration (matching) quality:
For the (doc vs catalogue) image comparison, the image similarity score may for example be computed as follows:
a. Compute image similarity scores using a registration quality score using the number and weight of the features returned from the images registration process.
b. The ‘registered’ image is transformed into the catalogue image proportions. Then, subtract the RGB values pixel-by-pixel and compute the normalized absolute sum over all pixels of the subtraction image, yielding a single scalar that quantifies the similarity between the catalogue and the document image
c. Colour histogram comparison-

A colour histogram may be computed for the catalogue and for the reviewed document image. These histograms quantify the number of pixels for each RGB value appearing in the two images (for example—the RGB value (255,0,0) appears x times in the doc image, and y times in the catalogue image).
d. For each RGB value—the difference in the number of occurrences between the two images may be computed x-y
e. The registration quality final score may be computed as the sum of these absolute difference over all the possible RGB values
f. OCR image to text on the image, and comparing the catalogue image text to the document image text
g. These plural e.g., 4 similarity scores, are then combined e.g., averaged to yield a single image similarity score %, which is then used to evaluate the document vs catalogue image similarity.

### g. Tabular Data Extraction and Matching Operation 300

This operation typically scans regions in the document that were previously tagged as data in a tabular format. After a table is identified, the data in the table is extracted, and formatted into a col/row, per cell, format.

Any suitable method may be used for computing similarity between a scanned table in a new document being checked for compliance, vs a table stored in the catalogue. This similarity score may, for example, include parameters such as the vertical and horizontal axis titles similarity and/or number of identical cols and/or number of identical rows, and/or total number of identical cells. This score is then used to compare each table in the document to tables stored in the catalogue, and accordingly, to mark the table as either new content if similarity is below a threshold, or as a table which matches an existing table in the catalogue, whose similarity is above the threshold.

Example logic for performing this operation may include all or any subset of the following relative % match score computation operations:

Compute % of identical columns and col head between the tables: comparing each table 1 col with each of table 2 cols and counting each matched col). This is then normalized by dividing the total number of cols.

Compute % of identical rows and row head between the tables: comparing each table 1 row with each of table 2 rows and counting each matched row). This is then normalized by dividing the total number of rows.

Compute % of identical cells between the tables: comparing each table 1 cell with each of table 2 cell and counting each matched cells). This is then normalized by dividing the total number of cells.

The relative % match scores, once computed, may then be combined e.g., averaged, to compute a total table similarity score (0->100%) expressing how similar the table in the new document is, to some table in the catalogue.

### h. Reference Identifications

This functionality may be performed by operation 140 in the main flow which is configured for locating references (e.g., actual references and places in the document where these references are pointed to).

It is appreciated that in the main flow, operation 290 checks if a catalogue required reference appears in the scanned document. Operation 290 is typically performed after operation 140.

In h, references pointers and starters are initially extracted from the documents, so these extracted reference pointers and/or starts may be compared, e.g., in operation 140, to references required by the catalogue.

Operation h aka operation 140 may be configured to identify any parts of the text that are pointers to references inside the text, and then may be configured to match each of these reference pointers with its actual reference text.

Identifying reference pointers/starters inside the document phrases typically uses unique reference character features, such as font size, superscript, and special commonly used reference chars, to identify reference pointer candidates. The method typically also handles cases where there is a list of references (such as 1, 4, 5 following a word in a sentence, e.g., the sentence's final word, aka end word. Typically, this operation is also configured to detect cases where the reference is in a range of references format (for example “see references 1-4”).

The list of reference pointers & starters is then scanned to map each of the reference pointers with the referenced text (ref starter), and extract a full list of references used in the new document whose compliance is being checked.

This document reference list may then be compared to required correct references marked in the product catalogue, and the number of found and missing references may be computed.

### i. Identifying Item Lists Operation 150

Any suitable technology may be used to identify parts of the text which form an item list. These lists may include text sequences such as: 1 . . . 2 . . . 3 . . . /a . . . , b . . . , c . . . d . . . /I, II, III. The system may scan the document for each of these types of list markers, and identifies this type of item lists. These item lists can be arranged either horizontally, or vertically. The system locates the most similar or identical list in the reviewed document, compares the two, and alerts the user of any extra/missing information.

Typically, item list identification includes scanning the document and checking the first word in each phrase. For each first word the process checks whether this first word belongs to one of the possible first elements in one of the types of lists e.g. as defined elsewhere herein. If the first element of a list was located at the beginning of a phrase, the process continues to the next item list starter, and checks if this element can also be found in the text that follows. If three (parameters) or more elements are found, the section may be defined as a list, and each of the elements may be stored as a single entry in the item list table.

### j. Modular Content

This may be handled by operation 270 and/or operation 280 in the main flow. These operation/s enable/s the user to define a set or structure of rules which are then used to validate reviewed document content against an existing modular content catalogue typically including validating that the document contains all of the modular content elements included in the modular content catalogue.

This validation may include all different types of content, such as all or any subset of:
Images and tables validation (e.g., using table comparison as described elsewhere herein or any suitable known method)
Single phrase Important Safety Information text check (ISI information which is split into single phrases)
Sequence of ordered catalogue entries check (validating an entire ISI paragraph).

Typically, modular content validation enables user/s to create a specific modular content catalogue for each product. This modular content catalogue is then used to review and validate processed documents e.g., as described herein in the main flow.

The modular content library may include a list or set of a number of separate modular content blocks. Each of these blocks defines a specific content section (such as important product safety information, product indications, contradictions etc.). These blocks resemble regular text paragraph sequences, but can also include non-textual content, such as images, graphs, and tables. This content might sometimes appear in the document split over a number of different areas and in different pages.

The validation process typically includes modular content block validation-checking that the checked document contains each of any required blocks, including all the different text content and other media included for this block, as defined in the product modular content catalogue. The validation process typically also verifies that this content appears in the correct order as defined in the product catalogue.

Review of a scanned or new document may include validating that the document contains all of the modular content blocks defined e.g., as required in the product catalogue. After this content check is performed, the system may generate check summary output tables. The data in these tables may then be used to alert the user of any missing content, extra content, or content appearing in an incorrect order.

Creating a modular content catalogue block may include all or any subset of the following operations, suitably ordered e.g., as follows:
The user is prompted to define a new catalogue block entry, which may include block general information such as all or any subset of the following block metadata: block name, type, sub-type, and general description.
The user is prompted to mark block content regions (e.g., bounding boxes) over a single or number of catalogue documents previously imported to the system.
The system scans the catalogue document, collects, and records all the content included inside the user-defined bounding boxes which typically account for, or take into account, or identify, different possible media types—such as text, images, tables and graphs. This data is then added to the modular content product catalogue.

The system is typically configured to handle plural types of modular content. Each modular content block can include a single or a number of items. Each of these modular content items can be of various content types such as any of the following:
i. Single catalogue text phrases such as important safety information phrases which are allowed to be split into single phrases (e.g. as described below).
ii. Ordered sequence of catalogue entries such as complete important safety information paragraphs (e.g., as described below), This ordered sequences content type typically requires that the sequences will appear in the document in the correct order. This order is typically the same order of appearance as in the catalogue reference catalogue entry. It may be used to check whether an entire paragraph, or number of paragraphs (an entire section) can be found in the reviewed document.
iii. Images content (e.g., as per functionality f described herein): this content can include different types of image formats, such as JPG, GIF, BMP, or PNG images files.
iv. Tabular content (e.g., as per functionality g described herein): This is content which appears in the document in the form of tables. This content is processed and stored in the system as a structured table (not using regular text format).
v. Graphs: This includes content which is arranged using x and y coordinates. It may contain one or more overlapping graphs, arranged over a 2-dimensional x, y coordinate system.
vi. Reference list. A list of defined available professional literature resources references.
vii. Contact information, such as telephone numbers, physical address, emails address, and URLs.

In order to validate that any required catalogue content can be found in the reviewed document, for each type of these content types a suitable content matching algorithm may be used.

Any suitable matching process may be used for each of the content types Iii-vii above, e.g. as described herein with reference to operations 140, 150, 250, 270, 300, and methods f1, f2, f3.

All or any subset of operations 140, 150, 250, 270, 300, and methods f1, f2, f3 may be used for modular content validation.

The following matching process, for single catalogue text phrases, such as single phrase “important safety information”, may be used for content type I as defined above.

This matching process is configured to allow tolerance for minor non-critical differences between the searched catalogue phrase and the scanned document phrase.

In order to implement an exact text to catalogue phrase matching, while still maintaining enough sensitivity to enable detection of relevant missing or changed document text, the system typically performs initial text cleaning, which typically includes removing document specific references characters, and accounting for single extra/missing characters, which are caused by non-significant document layout differences. Following this text cleaning, the matching may be performed by scanning the reviewed document phrase by phrase, and computing the similarity between each of these phrases to the specific catalogue phrase searched. This similarity is computed by computing the minimum number of word ‘swaps’ required to transform the scanned phrase word sequence to the searched modular content catalogue phrase word sequence.

The following matching process, for full paragraphs, such as multi-phrase important safety information (ISI), may be used for content type ii as defined above. The process typically scans the document and validates that each modular content catalogue ISI section appears in the document with the correct phrase order as defined in the catalogue. Since each of the phrases in the catalogue ISI can have multiple occurrences in the document, and since the segmentation and order of these sections can change between different documents, this validation process typically includes locating a most probable occurrence of the ISI catalogue paragraph in the document. This search algorithm may be applied by scanning the document, and identifying possible occurrences of any required catalogue paragraph. The process then typically uses a statistical model such as bag of words to find the most probable phrases sequences in the document resembling the catalogue phrase sequence, and to map each catalogue phrase with its matching document phrase. The process typically selects the sequences with the maximal number of matched phrases for each section.

The process typically uses the results of this search to determine whether each entire catalogue ISI paragraph can be found in the reviewed document. The process may then present system output indications to the user of any missing, extra, or swapped sentences in the checked document compared to the full catalogue paragraph in the modular content catalogue.

### k. Important Safety Information: Single Phrases

e.g. as per operation 270

This algorithm scans the document, and checks that any required ISI phrases in the catalogue appear in the new document being reviewed. The process may employ conventional text cleaning and phrasing algorithms to allow enough tolerance for minor non-critical differences between the catalogue and the document, while still maintaining enough sensitivity to enable it to detect missing or changed document text. This may, for example, comprise first cleaning both the document data and the catalogue data, transforming the text into lower case text, and removing ‘noisy’ characters such as hash, minus, commas, periods etc.

### l. Important Safety Information aka ISI: Full Paragraphs

The summary of each medication's risk may be headlined “Important Safety Information”.

This operation scans the document and validates that each ISI section, or paragraph in the catalogue, also appears in the document being reviewed for compliance, and has the correct phrase order. It is appreciated that each of the phrases in the catalogue ISI can have multiple occurrences in the document e.g., because the graphical layout of different versions for the same product brochures/documentation, can very often change and can be re-split/shuffled over pages/paragraphs.

Since the format and order of these sections can change between different documents, this validation operation typically includes locating, in the new document, the most probable occurrence of each ISI paragraph appearing in the catalogue e.g. by scanning the document, so as to identify possible sub-sections of any required catalogue paragraph, then using a statistical model to find the most probable order and location of these catalogue subsection phrases in the document, and mapping each catalogue phrase with its matched document phrase, validating that the entire ISI paragraph does appear in the document, and alerting the user of any missing phrases, gaps, or swapped sentences in the new document being checked for compliance. This above-described operation is typically part of the review process, e.g. of a new document, performed using an existing catalog.
This statistical model/s typically comprise/s a general model/solution designed to address the problem of matching a reviewed document to a catalogue text.

This statistical model may be applied after the ‘catalog match’ process e.g. by scanning the documents, and for every catalog matched ISI phrase, locating any following phrases which match the following catalog ISI phrase. Since some ‘gaps’ and missing ISI phrases sometimes occur, this process allows some tolerance during the document scan. This prevents the system flagging an ISI section as missing, which still indicates to the user when these sections do not fully match to the ISI catalog.

The document and the catalogue documents can have these sequences re-arranged, and can appear in different ordering and/or appear in different pages, and/or may be split differently over different documents.

Matching may include mapping each catalogue phrase to the most probable document phrase e.g., by first finding all occurrences of each catalogue phrase in the reviewed document. For example—the title phrase “Important Safety Information”, can appear in a few different locations in the document; the system may need to find the occurrence that is followed by a specific sequence of phrases which refers to a single warning Information type.

This correct 1-1 mapping/order for each catalogue phrase may include finding the sequence that involves the least number of required “shuffling”/re-ordering” to the compared catalogue ISI.

FIGS. 25-31 describe label change in accordance with certain embodiments. An example of label change is that a medication label may change from warning against use ‘under 12 years old” to->“under 6 years” e.g. because the medication has received FDA approval to use the drug for 6 year olds and above patients, instead of 12 years and older, previously.

Typically, a change in regulations or other guidance occurs in a library, and the system may be configured to pinpoint document/s that need to be changed responsively and/or to highlight the content (phrases/tables/figures/modular content) in the document that needs to be changed.

FIG. 25 shows label change creation which holds the effected product, library, and a short description of the change, for example change of approved age of usage from X years to Y years.

In FIG. 26 a user assigned a list of documents that should be checked, and in addition a sample of the documents changed area is tagged (e.g. for an ML search in later documents). The “process” action button runs a process of searching for suspected need to change areas in the documents.

In FIG. 27 a user assigned the list of documents that have been changed, and such changes should be validated. The “process” action button runs a process of searching for changed areas and validation that the change is correct.

FIG. 28 provides a first list of invalid blocks, both tagged and detected.

FIG. 29 provides a second list of invalid phrases, both tagged and detected.

FIG. 30 provides a first list of valid blocks, both tagged and detected.

FIG. 31 provides a second list of valid phrases, both tagged and detected.

It is appreciated that any subset of the illustrated content may be provided, for any of the drawings. Also provided is logic for generating all or any subset of the content shown in the example system screens and selection menus of the drawings.

Many variations of the embodiments specifically described herein are possible. By way of non-limiting example:

It is appreciated that drug manufacturers put out new versions of drug literature not infrequently, e.g., because new indications for a drug have been approved, or because new claims can now be made based on new clinical data. once the new content is approved, all or portions of the new content may then be used to update the catalogue. For example, after each new document is checked, the system may prompt the user to indicate whether or not s/he wants the catalogue updated accordingly. Optionally, the system may show the user all differences between the catalogue and new document just approved and user selects whether all of those should be used to update the catalogue, or only a designated subset of those.

According to certain embodiments, the system provides versioning control in the system of the drug literature in the system and/or of the approved libraries in the system. Typically, the library is published each time changes are made. the prechecked documents may have a “check with latest library” notification.

According to certain embodiments, phrases may be classified as being either “variable” “non-variable” or “new content”. “non-variable” phrases may be those in which critical medical information exists, such as term of use and dosage, whereas “variable” phrases may simply include general notes.

this helps pinpoint deviations that need further editing by the authoring tool.

It is appreciated that some or all deviations may be handled automatically, with or without human approval of each, or the human user may manipulate the authoring tool to hand-fix some or all deviations, with or without machine-generated suggestions.

According to certain embodiments, the system generates various KPIs, and reports which flags are indicated, or pinpoints or highlights non-compliant or non-approved content. The system user may use the error report to go back into legacy systems such as Adobe InDesign to make the changes. The system use may then re-upload the corrected document into the system described herein, to determine that the corrected document is compliant, until, eventually, a compliant document results. Alternatively, the system may be integrated into an authoring tool/s such that there may be no need to re-upload; the system may, for example, be implemented as a macro in the authoring tool.

According to certain embodiments, KPIs are fixed, although, alternatively, a suitable user interface is provided to enable users to request user-defined KPIs.

Any desired deviations between a new document and its library may be flagged, such as but not limited to all or any subset of the following: new aka wrong aka non-matched content, missing content, and wrong order of content. If a user indicates that flagged non-matched content is correct, this content is no longer considered incorrect.

It is appreciated that a single manufacturer may produce plural different drugs, which may have certain internal compliance standards that apply to all drug literature regarding any of the plural drugs. Typically, plural respective catalogues are formed. There may be separate libraries for each of several indications of even a single drug. There may be associated, separate libraries for different marketing or use channels, such as insurance payer information, health care professionals (branded and unbranded), and direct to consumer marketing (branded, unbranded, disease state).

Typically, the system is configured to ensure that any library does not include “artifacts”. For example, the system is designed to avoid situations in which the system builds the library under the assumption that each document must begin with the header: “11 Jun. 2022”, simply because the examples of literature that the company uploaded all happened to begin with that header. Instead, a rule may be provided to validate that the date in the new document is changed relative to the catalogue document's date, and to alert otherwise.

A catalogue or library may include (typically each in a separate tab e.g., as shown in FIG. 2) all or any subset of the following library elements:
List/s of approved phrase
List/s of approved tables/graphs/images
List/s of approved modular contents

A catalogue may also include all or any subset of a pdf file, a set of business rules, a character list, a set of images, and a list of references.

In the specification, the terms “catalog” and “library” may be used interchangeably. Also, the terms compliance, consistency, and accuracy, may be used interchangeably.

It is appreciated that there may be various types of system rules, aka regulations, or regulations such as, say, government regulations or other regulations applying to all the system's end-users, brand rules (aka product rules) applying to a single product by a single organization, and corporate rules (which may apply to all of a given organization's products, and all end-users associated with this organization, but not to other organizations/end-users).

Examples of governmental regulations may be:
Example 1: efficacy claim must travel with supporting clinical data.
Example 2: important safety information must appear throughout the promotional material, in the approved FDA format.
Examples of brand regulations may be:
Example 1: specific colors and images must be used.
Example 2: specific spacing between content must be in place and consistent throughout.
Examples of corporate regulations may include:
Example 1: company name must always appear at the bottom left-hand corner of the document.
Example 2: company address must be listed as the headquarters address.

It is appreciated that the automation of the system does not rule out manual insertion of brand rules e.g., by manually updating a relevant library pertaining to the brand to indicate, say, that content “a” in each new document must match the library 100%, whereas content “b” in each new document can be variable.

The system described herein may include all or any subset of the following: Consumer content management, including all or any subset of the following functionalities:
Manage the life cycle of the document review process.
Load new marketing content for review (pdfs, textual numerical and graphical content).
Allow users to build and manage catalogues of pre-approved content.
Create manage and apply, content review rules check list for different products.
Perform comprehensive cross-check of the consumer medicine information during validation of new marketing content.
Deliver KPIs and progress report during the review process.
Assign different documents and tasks to different users for review
Enable tracking of the entire review life-cycle progress

Document reviewing and inspections tools (GUI) may include all or any subset of the following functionalities:
A dedicated pdf viewer tool for the inspection of pdf documents during the review process.
Panning and zooming on the entire reviewed document and allowing to focus on specific pages/phrases/words.
Highlighting reviewed phrases during the review process, to compare against the catalogue.
Visually mark and indicate valid vs non-approved content.
Deliver specific warnings for non-approved and new content.
Allow GUI for editing and viewing results of specific rule-based content checks.
Highlight content references, and match the reference phrase to the referenced phrase. Inspection of the review process progress may include all or any subset of the following functionalities:
Compare reviewed content to catalogue
Alert for any new content/phrase which was not pre-approved and can be used in the product content.
Alert for any required content/phrase which was not found in the reviewed content.
Show the most similar phrases already existing in the product catalogue.
Suggest, per phrases, the extra/missing words, compared with the most similar catalogue entries.
Show any variations between the inspected material and the existing catalogues.
Tool for generating reports for the review progress
Report the number of phrases with existing catalogue matches vs non-matching phrases.

The system user's environment and permissions management tool may include all or any subset of the following functionalities:
Create separate user environments for different users associated with companies/documents/catalogues when managing the review process.
Manage users with different permissions, roles, and tasks associated with each user or group of users.
Content catalogues management tool—manage and maintain user, product and company specific pre-approved content DB tables.

Any embodiment of the system of the present invention may include all or any subset of the following functionalities:

### Text Reading Order

understanding the correct reading order of words in their “natural” reading order
from chars->words->phrases->full ordered page. Account for variation in alignment/font size/type

### OCR Text

extract OCR text and combine with any ‘plain’ text included in the document

### Image Segmentation

segment normal images and segment drawings by identifying drawing “clusters)

### Image Identification and Comparison

Extract ‘plain’ images, layout parser images, and catalog image (image registration)

### Removing Invisible Text

Check if text in pdf body also exists when performing OCR (and also use adjustable zoom)

### Text Matching

Phrase s similarity score by calculating the minimum number of words
modification/resorting required.

### Split/Merge Phrases

scan through doc with a ‘sliding a window’ and check if text can be merged or split into phrases which ae included in the catalog, (always take the longer word. Use text similarity score)

### Phrase Classification

Use both ML (bag-of-words) and also text comparison/similarity to phrases with already known class.

### Flexible Text Search/Comparison

### Modular Content—Define & Check Rules

Functionality to allow the user to check the document for specific content. Where the content can have different types (single phrases/multi phrases, images, references, table, graphs)

### ISI/ISI Splitted Rule Definition and Checking (Sorted Phrases Search)

For a multi-phrase ISI content, the algorithm attempts to find the most complete (longest) sequence of ISI catalog phrase set in the document, accounting for ‘gaps’ and ‘discontinuities’ and wrong order of phrases.

### Text Comparison Per Word (Missing Extra Words)

Generate a single “comparison” output phrase, identify missing and extra words. Create a comparison sorted word vector (finding the most probable relative location of missing and extra words, in the combined comparison output.

### Reference Locating and Matching

Identifying reference ‘starter’ and ‘pointers’ using various features (special chars, font type/size/location). Matching potential starters and pointers, to create a unified pointer<->starter list.

### Auto Web-Search for Reference Text On-Line

Identify and extracting the reference title text. Use conventional search engine for automatic search of the referenced text.

### Lists Recognition and Extraction

Identify phrases in text which compromise of a single list of elements, by searching for typical list structure (such as 1., 2., 3. And a., b., c. etc.)-

### Tables Recognition and Extraction

locating tables in the document. Extract table elements into a x, y formatted array table. Extract col and rows header. Comparing to catalog tables using a table match-score (by looking at max number of matched rows and columns. Smart table comparing also applied by calculating the minimum number of rows/cols swaps to transform table 1->table 2)

### Graphs Recognition and Extraction

locating graphs in the document. Extract graphs a x, y points, and x, y axis.

Comparing graphs to graphs in the catalog (number of matching x,y points, and x,y axis titles

### Contact Details Find and Extract

Extract contact information (url/email/telephone/physical address) by searching for specific template for each-
(for example: url->xxx.xxxx.xxx, email->xxxx@xxxx.xx, telephone->xxx-xxxxxxxx)

### Pdf Report Creation

Create pdf summary output, using the original document & super imposed pdf ‘comment’ per sentence, highlighting the phrase review status, and other review statistics

### GUI for Pdf Viewer

Pdf document viewer with page selection, pan, zoom features. Enable highlighting specific text section (single or multiple) with a bounding box. Enable search text functionality.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.
Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.
   Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently, rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored, e.g. in memory, or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein that impacts, in a positive manner, a problem or objectives described herein; and (b) outputting the solution.

The system may, if desired, be implemented as a network- e.g., web-based system employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients, e.g., mobile communication devices such as smartphones, may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if -then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth, or Zigbee.

It is appreciated that implementation via a cellular app as described herein is but an example, and, instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include an apparatus, whether hardware, firmware, or software, which is configured to perform, enable, or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately, or in any suitable sub-combination, including with features known in the art. Each element e.g., operation described herein may have all characteristics and attributes described or illustrated herein, or, according to other embodiments, may have any subset of the characteristics or attributes described herein.

1. A system facilitating authoring of content, the system comprising:
a plurality of catalogues (aka “data catalogues”) associated in memory with, and storing, in said memory, data regarding, a respective plurality of authorized documents, each having content known to be compliant with at least one regulation; and
at least one hardware processor configured to interface with plural end-users and to review at least one new document comprising a new version associated by an individual end-user from among the plural end-users with an individual authorized document from among said plurality of authorized documents, by comparing the new document to the catalogue from among said plurality of catalogues which is associated in memory with said individual authorized document and, accordingly, generating at least one output facilitating editing of the new document for compliance with said regulation.

2. A system according to claim 1 and also comprising automated functionality for creation, management, and storing of catalogues, thereby to provide said plurality of catalogues.

3. A system according to claim 1 wherein said output comprises at least one KPI.

4. A system according to claim 1 wherein said output comprises at least one error report.

5. A system according to claim 1 wherein each of the plural end-users is defined as a system user and at least one of the plural end-users is associated in memory with at least one catalogue C to which at least some other end-users from among the plural end-users do not have access, by creating a work environment in which the catalogue C is created and associating the plural end-users with different work environments in which different catalogues are created.

6. A system according to claim 1 wherein the hardware processor identifies phrases in at least one new document, and, when reviewing at least one new document, performs at least one phrase-level analysis of the new document on said phrases.

7. A system according to claim 6 wherein, before performing said phrase-level analysis, the hardware processor merges at least one sequence of at least two consecutive phrases identified in said at least one new document, into a single phrase, and performs said phrase-level analysis on said single phrase inter alia.

8. A system according to claim 6 wherein, before performing said phrase-level analysis, the hardware processor splits at least one phrase identified in said at least one new document, into two consecutive phrases, and performs said phrase-level analysis on each of said two consecutive phrases inter alia.

9. A system according to claim 1 wherein said hardware processor is configured for finding modular content in said at least one new document.

10. A system according to claim 1 wherein said hardware processor is configured for detecting at least one of tables/graphs/blocks in the new document.

11. A system according to claim 1 wherein said generating at least one output comprises highlighting at least one deviation between content of said at least one new document and said catalogue.

12. A system according to claim 1 wherein the system is in data communication with at least one document authoring system used by the plural end-users to author the at least one new document.

13. A system according to claim 11 wherein said document authorized system is also used by the plural end-users to author said plurality of authorized documents.

14. A system according to claim 12 wherein said document authoring system comprises a word processor.

15. A system according to claim 12 wherein said document authoring system comprises image editing software such as but not limited to Photoshop.

16. A system according to claim 1 wherein said comparing the new document to the catalogue comprises determining word order in the new document, and then comparing order of content in the new document to order of the same content in the catalogue.

17. A method facilitating authoring of content, the method comprising:
Providing a plurality of catalogues (aka “data catalogues”) associated in memory with, and storing, in said memory, data regarding, a respective plurality of authorized documents, each having content known to be compliant with at least one regulation; and
Using at least one hardware processor configured to interface with plural end-users to review at least one new document comprising a new version associated by an individual end-user from among the plural end-users with an individual authorized document from among said plurality of authorized documents, by comparing the new document to the catalogue from among said plurality of catalogues which is associated in memory with said individual authorized document and, accordingly, generating at least one output facilitating editing of the new document for compliance with said regulation.

18. A computer program product, comprising a non-transitory tangible computer readable medium having computer readable program code embodied therein, said computer readable program code adapted to be executed to implement a method facilitating authoring of content, the method comprising:
Providing a plurality of catalogues (aka “data catalogues”) associated in memory with, and storing, in said memory, data regarding, a respective plurality of authorized documents, each having content known to be compliant with at least one regulation; and
Using at least one hardware processor configured to interface with plural end-users to review at least one new document comprising a new version associated by an individual end-user from among the plural end-users with an individual authorized document from among said plurality of authorized documents, by comparing the new document to the catalogue from among said plurality of catalogues which is associated in memory with said individual authorized document and, accordingly, generating at least one output facilitating editing of the new document for compliance with said regulation.
